(19) United States
(12) Patent Application Publication
(10) Pub. No.: US 2003/0090716 A1
(43) Pub. Date: May 15, 2003

(54) Management information transmission apparatus, apparatus management apparatus, and apparatus management system

(75) Inventor: Akito Umebayashi, Tokyo (JP)

Correspondence Address: GREENBLUM & BERNSTEIN, P.L.C., 1950 ROLAND CLARKE PLACE, RESTON, VA, 20191, US

(73) Assignee: Matsushita Graphic Communication Systems, Inc., Tokyo (JP)

(21) Appl. No.: 10/280,000

(22) Filed: Oct. 25, 2002

(30) Foreign Application Priority Data
Nov. 9, 2001 (JP) 2001-344655

(51) Int. Cl. B41J 1/00; G06F 15/00

(52) U.S. Cl. 358/1.15

(57) ABSTRACT

An agent side separately maintains a template, which is a management information item list and describes an encoding method, and actual data of the management information. The agent side transmits item list and the actual data that is encoded by the encoding method described in the item list to a manager side. Accordingly, not only the agent can transmit all of the management information items required by the manger with one SNMP reply, but also the manger can securely decode the received management information.

### BACKGROUND OF THE INVENTION

1. Field of the Invention

The present invention relates to a management information transmission apparatus that transmits management information toward other apparatuses that are connected to a network, apparatus management apparatus and system that manage management information.

2. Description of Related Art

Due to the significant development of computer apparatuses and communication technologies in recent years, computer networks have widely become available, various types of devices that are connected to networks are employed, and the number of such devices has grown at the same time. In addition, network management software that can effectively manage such network and various device information connected to the network has become common especially in large corporations.

Conventionally, several proposals have been made as for the methods of managing devices that are connected to networks. For example, International Standard Organization (ISO) has proposed a multi-use standard framework that is referred to as Open System Interconnection (OSI) model. However, currently the Simple Network Management Protocol (SNMP) is more widely used, which is one type of Internet protocols.

The network management system network according to the SNMP includes, as basic constituents of this system, at least one network management station, managed node in which software (agent) operates, and network management protocol that is used by the network management station and agent for exchanging management information. A user uses network management software, which is referred to as manger of the network management station, communicates with the agent at the managed node, and obtains/changes the data of the managed node.

The agent, on the other hand, maintains data related to the status of the managed node itself in a database format. This database is referred to as Management Information Base (MIB), having a tree shaped data structure and entire nodes uniquely numbered. Each node includes a unique identifier made of numerical character string, which is referred to as an Object Identifier (Object ID). When the user make a data obtaining request (GETREQUEST or GETNEXT REQUEST) or data change request (SET REQUEST) toward the managed node, the management software transmits the request type and object ID information to the agent at the managed node. The agent then analyzes the request type and object ID information, generates corresponding data, and sends back the response to the manager (GETRESPONSE). TRAP, a system in which the agent's status changes is informed to the manger as a preset notification destination, is also provided.

Recently, a private MIB, such as a corporation expansion MIB that is defined by individual corporation and organization, is becoming increasing popular, for uses such as job management, billing management, address book setup, etc., instead of using a standard MIB that is provided in SNMP managed apparatuses as a standard. When employing such a private MIB, accesses to a two-dimensional table becomes very frequent. It is noted that even when the already-existing MIB is used, the access to the two-dimensional table can become frequent. However, this protocol is conventionally used as a managing apparatus/system protocol and not used for fields that require real time responses.

Also, when accessing an MIB in a table format where a plurality of objects are included in one table, there is a risk that users may have a conflict with others when setting data. For example, while one terminal is obtaining table information of the apparatus using a job management application, another terminal could update the information, which creates a contradiction in the information.

When setting apparatus management information, the manger can employ a method that monopolizes the session. However, when a monitoring job performance status and deleting a job, an indefinite number of terminals can access the MIB. Therefore, there is a higher risk that the information becomes undefined due to the control conflicts.

Additionally, a table is configured with various objects and a single cycle communication is required for an access for each object, thereby creating a problem of taking time for obtaining/updating the entire table, i.e., increasing the communication load of the network.

Moreover, there is a method of encoding the objects in the table as a whole, e.g., a structure in the C-language, so that a plurality of objects can be obtained/setup in one cycle communication. However, when encoding a plurality of objects in the abovedescribed method that is dependent on a specific environment, this encoding method format obviously becomes unique to such apparatus. Therefore, both agent and manager have to be informed of such encoding method.

However, even if both agent and manager are informed of one encoding method, the encoding method may need to be changed because of adding/deleting/changing the object at the agent side. In such a case, the encoding method for the manager has to be changed into an encoding method used by the agent every time, which may alternately require the change in the software.

### SUMMARY OF THE INVENTION

This invention is provided to address the above-described problems. The object of the invention is to enable a plurality of management information items to be processed in one communication cycle, by handling the plurality of management information items as a single unit.

According to the present invention, an agent side separately maintains a template, which is a management information item list and describes an encoding method, and actual data of the management information. The agent side transmits item list and the actual data that is encoded by the encoding method described in the item list to a manager side using the SNMP protocol.

Accordingly, not only the agent can transmit all of the management information items required by the manger with one SNMP reply as a single unit, but also the manger can securely decode the received management information. Therefore, the present invention can provide a management system that is highly responsive.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a configuration of an apparatus management system according to the first embodiment of the present invention;

FIG. 2 is a block diagram illustrating a configuration of a PC used in the apparatus management system according to the first embodiment of the present invention;

FIG. 3 is a block diagram illustrating a configuration of a printer apparatus used in the apparatus management system according to the first embodiment of the present invention;

FIG. 4 is a functional block diagram of the printer apparatus according to the first embodiment of the present invention;

FIG. 5 illustrates an MIB database structure according to the first embodiment of the present invention;

FIG. 6 illustrates an MIB database that is described by protocol syntax regulation language ASN. 1 according to the first embodiment of the present invention;

FIG. 7 illustrates a method of defining a tag template according to the first embodiment of the present invention;

FIG. 8 illustrates a data structure that is generated based on the tag template according to the first embodiment of the present invention;

FIG. 9 illustrates a module configuration of apparatus management software according to the first embodiment of the present invention;

FIG. 10 is a sequence chart illustrating an operation of the apparatus management system according to the first embodiment of the present invention;

FIG. 11 is a flowchart illustrating a process of the PC according to the second embodiment of the present invention;

FIG. 12 illustrates an MIB database structure according to the third embodiment of the present invention;

FIG. 13 illustrates a template for job control command description according to the third embodiment of the present invention;

FIG. 14 illustrates a data structure that is generated based on the tag template according to the third embodiment of the present invention;

FIG. 15 is a flowchart illustrating an operation of the PC in the apparatus management system according to the third embodiment of the present invention;

FIG. 16 is a first diagram illustrating a job list according to the third embodiment of the present invention;

FIG. 17 is a second diagram illustrating a job list according to the third embodiment of the present invention;

FIG. 18 is a flowchart illustrating an operation of the PC in the apparatus management system according to the fourth embodiment of the present invention;

FIG. 19 illustrates an MIB database structure according to the fifth embodiment of the present invention;

FIG. 20 illustrates a template for log description according to the fifth embodiment of the present invention;

FIG. 21 is a sequence chart illustrating an operation of the apparatus management system according to the fifth embodiment of the present invention;

FIG. 22(a) illustrates the list of logs stored by an apparatus to be managed at time T1 according to the sixth embodiment of the present invention;

FIG. 22(b) illustrates the list of logs stored by the apparatus to be managed at time T2 (=T1+α, T2>T1) according to the sixth embodiment of the present invention;

FIG. 22(c) illustrates the list of logs stored by the apparatus to be managed at time T3 (=T2+α, T3>T2) according to the sixth embodiment of the present invention;

FIG. 23 illustrates an MIB database structure according to the sixth embodiment of the present invention;

FIG. 24 is an operational flowchart illustrating an operation of the PC to set up a polling interval according to the sixth embodiment of the present invention;

FIG. 25 illustrates another MIB database structure according to the sixth embodiment of the present invention;

FIG. 26 is a block diagram illustrating the apparatus management system according to the seventh embodiment of the present invention;

FIG. 27 illustrates an MIB database structure according to the seventh embodiment of the present invention;

FIG. 28 illustrates a template for user information description and template for user control command description according to the seventh embodiment of the present invention;

FIG. 29 is a flowchart illustrating an operation of a PC to obtain user information according to the seventh embodiment of the present invention;

FIG. 30 is a flowchart illustrating a user information control by a PC in the apparatus management system according to the seventh embodiment of the present invention;

FIG. 31 illustrates an MIB database structure according to the eighth embodiment of the present invention;

FIG. 32 illustrates a template for address management information description and template for address management information control command description according to the eighth embodiment of the present invention;

FIG. 33 is a flowchart illustrating an operation of a PC obtaining address management information according to the eighth embodiment of the present invention;

FIG. 34 is a flowchart illustrating an address management information control of PC in the apparatus management system according to the eighth embodiment of the present invention;

FIG. 35 illustrates a structure of the apparatus management system according to the ninth embodiment of the present invention;

FIG. 36 illustrates a method for defining the tag template according to the ninth embodiment of the present invention; and

FIG. 37 is a flowchart illustrating an operation of updating a tag definition list in apparatus management system according to the ninth embodiment of the present invention.

### DETAILED DESCRIPTION OF PREFERRED EMBODIMENTS

The embodiments of the present invention are explained in the following, in reference to the above-described drawings.

First Embodiment

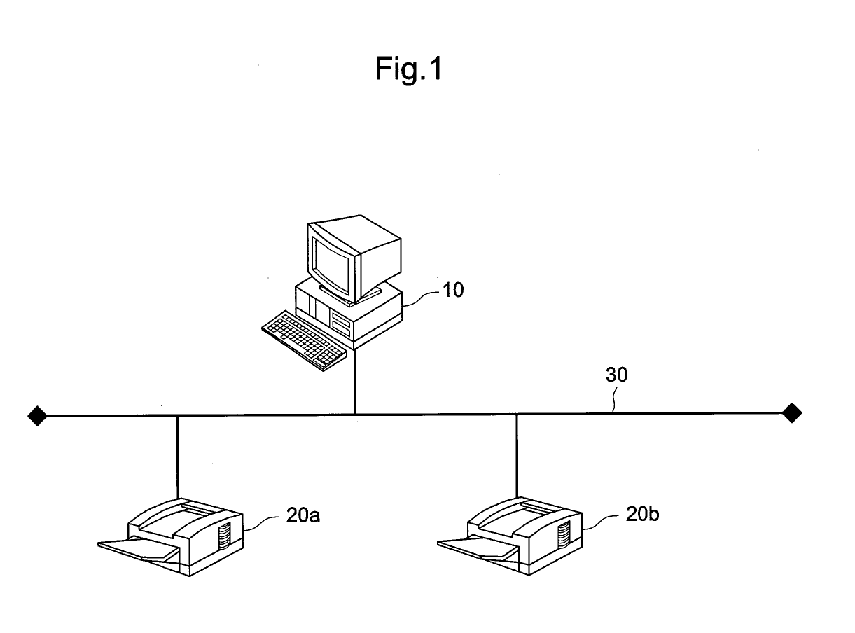

Hereafter, the apparatus management system according to the first embodiment of the present invention is illustrated in reference to the drawings. First, FIG. 1 is used to illustrate the configuration of the apparatus management system according to the first embodiment. FIG. 1 illustrates a configuration of the apparatus management system according to the first embodiment.

In FIG. 1, PC 10 (manager) operates an apparatus management software. Printers 20a and 20b (agent) are individually managed. PC 10 and printers 20a and 20b are mutually connected via communication medium 30 (e.g., network cable).

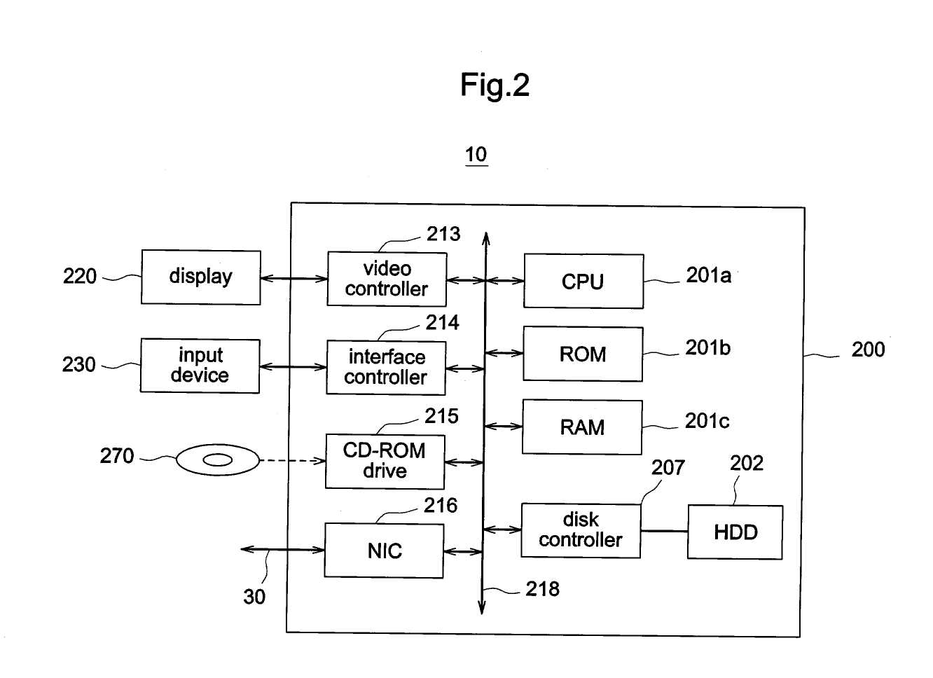

Next, FIG. 2 is used to illustrate the configuration of the PC used in the apparatus management system. FIG. 2 is a block diagram illustrating the configuration of the PC used in the apparatus management system.

In FIG. 2, PC 10 includes PC body 200, where the apparatus management software is operated, display 220, and input device 230. PC body 200 includes CPU 201a, which executes an apparatus management program that is stored in ROM 201b or hard disk 202, or retrieved from CD-ROM 270 by CD-ROM drive 215, in order to integrally control devices connected to system bus 218.

RAM 201c functions as a primary memory and work area of CPU 201a. Interface controller 214 controls instruction input from input device 230 (e.g., mouse, keyboard, etc.). Video controller 213 controls a display on display 220. Disk controller 207 controls accesses made to hard disk 202 and CD-ROM drive 215 that store apparatus management program. Network interface card 216 exchanges data with other apparatuses via communication medium 30.

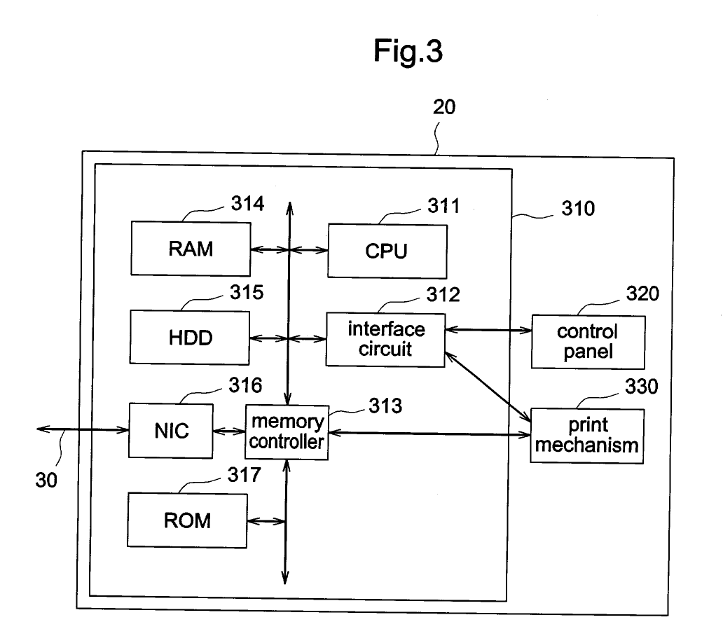

Next, FIG. 3 is used to illustrate the configuration of the printer apparatus used in the apparatus management system. FIG. 3 is a block diagram illustrating the configuration of the printer apparatus used in the apparatus management system.

In FIG. 3, printer 20 includes controller 310, control panel 320, and print mechanism 330. Print mechanism 330 includes a paper feeding apparatus, paper delivery device, printer engine, etc. Control panel 320 is an interface for the user to control printer 20, having a plurality of buttons to specify the operation for printer 20, and liquid crystal display panel and several LEDs that display operational status of printer 20 and the like.

Controller 310 includes network interface card 316, CPU 311, RAM 314, HDD 315, memory controller 313, ROM 317, and interface circuit 312.

In addition, control panel 320 is connected to interface circuit 312. Print mechanism 330 is connected to interface circuit 312 and memory controller 313. ROM 317 is a memory that stores data such as program codes.

CPU 311 controls each unit within controller 310 according to the program codes stored in ROM 317. Network interface card 316 communicates with other apparatuses via communication medium 30. RAM 314 is a memory apparatus that is used to temporarily store information such as print data that is received by network interface card 316 and intermediate code that is generated based on the print data.

HDD 315 is auxiliary memory apparatus that stores data such as MIB database and print data.

Memory controller 313 is a circuit that performs processes such as forwarding data to RAM 314 (and if necessary, HDD 315) from network interface card 316, and forwarding data to printer engine within print mechanism 330 from RAM 314, according to instructions given by CPU 311. Interface circuit 312 has several interface circuits for CPU 311 to exchange information with control panel 320 and the delivery device within print mechanism 330.

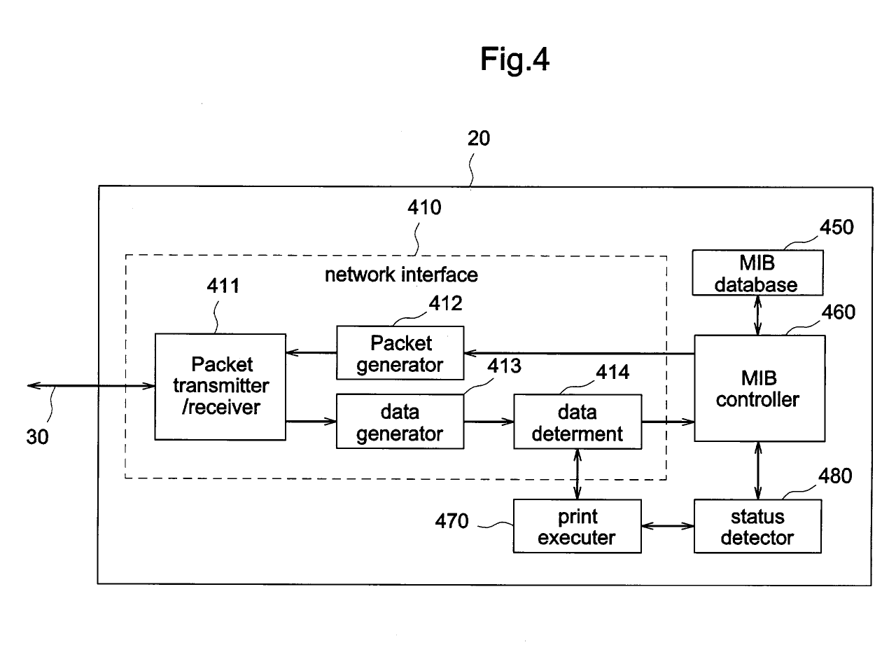

Next, FIG. 4 is used to illustrate the printer apparatus functions according to the first embodiment. FIG. 4 is a functional block diagram of the printer apparatus.

In FIG. 4, printer 20 operates as an apparatus that includes network interface 410, print executer 470, status detector 480, MIB controller 460, and MIB database 450. Network interface card 316 of FIG. 3 functions as network interface 410, while parts excluding network interface card 316 of FIG. 3 function as print executer 470 and status detector 480. Also, CPU 311, RAM 314, and HDD 315 function as MIB controller 460. In addition, HDD 315 of FIG. 3 corresponds to MIB database 450.

Network interface 410 includes packet transmitter/receiver 411 that exchanges a packet with another apparatus via communication medium 30, and data generator 413 that reconstructs data from the packet received by packet transmitter/receiver 411. Network interface 410 also includes data determiner 414 that provides the print data to print executer 470, when the data generated by data generator 413 is print data, and provides the data to MIB controller 460, when the data generated by data generator 413 is an SNMP message. Further, network interface 410 also includes packet generator 412 that generates a packet according to data given by MIB controller 460 and provides the packet to packet transmitter/receiver 411.

With the above-described configuration, network interface 410 provides print executer 470 with the print data that is transmitted to printer 20 from the other apparatus and provides MIB controller 460 with SNMP message that is transmitted to printer 20 from the other apparatus. Then, print executer 470 prints data on paper based on the printed data provided by network interface 410. Network interface 410 also generates packets according to the data given by MIB controller 460 and transmits the same to communication medium 30.

Status detector 480 has a function to detect status of each unit within printer 20, including print executer 470.

MIB database 450 includes MIB objects (hrDeviceStatus, prtMarkerTech, etc.) defined by RFC1514 (Host resource MIB), RFC1759 (Printer MIB) or the like. The content of MIB database 450 is rewritten by MIB controller 460 according to the status of each unit, which is detected by status detector 480.

When the data provided by network interface 410 is an SNMP message from the SNMP manager whose access is allowed (PC 10 of FIG. 1 in the first embodiment), MIB controller 460 controls network interface 410, retrieves information corresponding to the received SNMP message request (MIB object) from MIB database 450, and returns the information to the SNMP manager who sent the SNMP message. Access allowance is determined by checking a community string that is included in the data generated by the SNMP manager, for example.

Further, when the status of printer 20 changes, MIB controller 460 transmits a TRAP message indicating the change to PC 10 (apparatus set as a destination for TRAP). In other words, MIB controller 460 detects the status of each unit and updates the content of MIB database 450 when there is a status change. Moreover, MIB controller 460 transmits a TRAP message of the status change to PC 10, by controlling network interface 410.

In addition, in order to setup printer 20 with IP address and the like (community name, TRAP message destination, etc.) of PC 10, PC 10 (SNMP manager) informs printer 20, or the user performs the setup from control panel 320 of printer 20, which is similar to a general system based on the SNMP.

Hereafter, the MIB database according to the first embodiment is illustrated. The MIB database according to the first embodiment has a template in which an encoding method for encoding a plurality of elements is described. By obtaining the template from the agent, the manager can be informed of the encoding method for the elements used by the agent. Further, even if the encoding method employed by the agent changes for some reason, the manager is notified without delay of the changed encoding method.

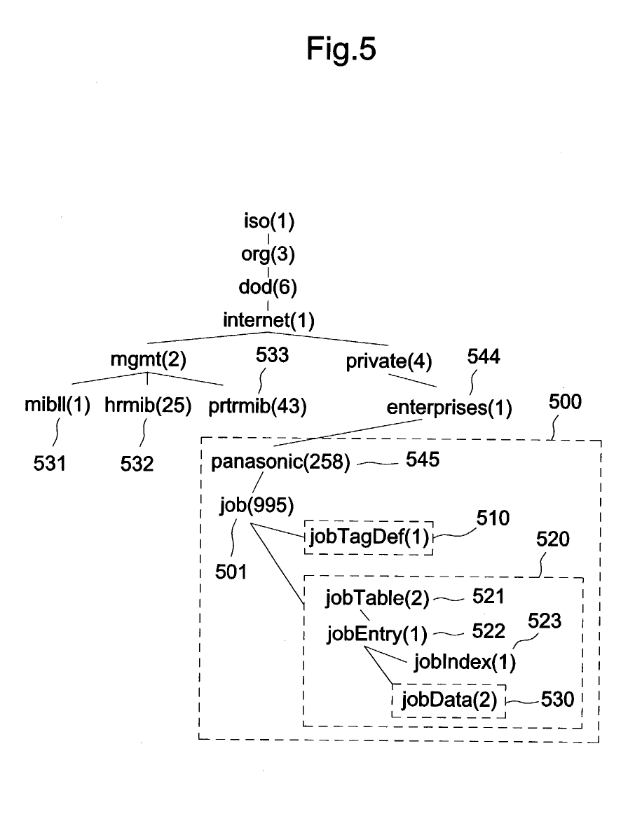

FIGS. 5-9 are used to illustrate the MIB database structure according to the first embodiment.

FIG. 5 illustrates the MIB database structure according to the first embodiment. As shown in FIG. 5, the MIB database is illustrated with a tree-shaped structure, having all nodes that are uniquely numbered. Each node includes a unique identifier made from a numerical character string, which is referred to as object ID (Object Identifiers). In the example of FIG. 5, “iso” a node name, and “(1)” after that is an object ID.

In both printers 20a and 20b, a standard MIB, which is installed as a standard by apparatuses managed by SNMP, and private MIB that can be originally expanded when a corporation or organization defines its original MIB.

For example, a standard MIB includes, in the same figure, mib-II (RFC1213 Management Information Base for Network Management of TCP/IP-based Internets:MIB-II) 531, hrmib (Host resource MIB (RFC1514)) 532, and prtmib ((Printer MIB) RFC1759) 533 relating to printers.

In this embodiment, Matsushita MIB 500 is used as a private MIB, an original MIB for Matsushita Electric Industrial Co., Ltd., which has an assigned corporation number 258 from the Internet Assigned Number Authority (IANA). Private MIB 500 is extended under Panasonic node 545 below enterprises node 544. Therefore, the private MIB can be extended below object ID 1.3.6.1.4.1.258.

Under panasonic node 545 of private MIB 500 includes job node 501, jobTagDef node 510 that illustrates a later described tag template, table 520 including job information, jobTable 521 that is a definition of table 520, jobEntry 522 that is an entry illustrating a summary list of information included in table 520, jobIndex node 523 that is an index of jobTable 520, and jobData node 530 that includes job information.

The structure of MIB is referred to as Structure of Management Information (SMI), which is regulated under RFC1155 Structure and Identification of Management Information for TCP/IP-based Interents, being defined using an OSI language, which is referred to as protocol syntax regulation language ASN. 1 (Abstract Syntax Notation One).

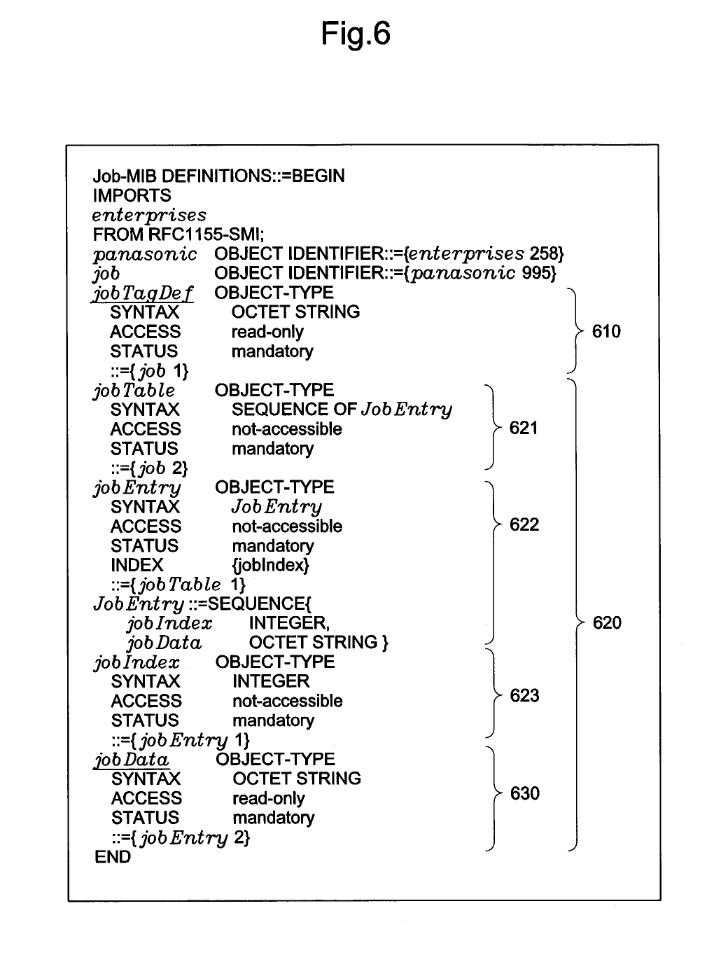

Next, FIG. 6 is used to illustrate an MIB database that is described by ASN. 1 according to the first embodiment. FIG. 6 illustrates the MIB database that is described by ASN. 1 according to the first embodiment.

jobTagDefnode 510 corresponds to description 610, while table 520 corresponds to description 620. Further, description 621 of description 620 corresponds to jobtable 521, description 622, to jobEntry 522, description 623, to JobIndex 523, and description 630, to jobData node 530.

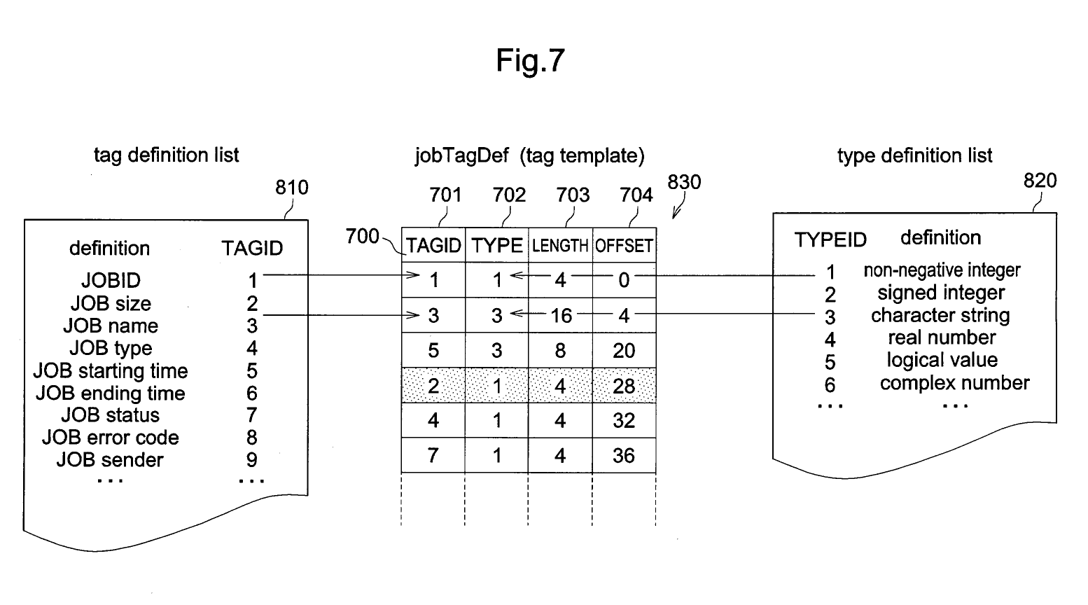

Next, FIG. 7 is used to illustrate a tag template (jobTagDef 510), which is used in the apparatus management system according to the first embodiment. FIG. 7 illustrates the tag template (jobTagDef 510), which is used in the apparatus management system according to the first embodiment.

Tag template 830 is defined as a set of data structure object 700. Data structure object 700 is a set of data structure list having a fixed length format, each including data tag number 701 (32 bytes), data attribution 702, data length 703, and offset value (from the first value) 704.

Data tag number 701 has one of the values of tag ID that is defined by tag definition list 810. Tag definition list 810 is stored in HDD 202 of FIG. 2 and HDD 315 of FIG. 3.

Tag definition list 810 is a table where an item relating to job information is assigned to TAGID. In tag definition list 810, JOBID is assigned to TAGID 1, JOB size to TAGID 2, JOB name to TAGID 3, JOB type to TAGID 4, JOB starting time to TAGID 5, JOB ending time to TAGID 6, JOB status to TAGID 7, JOB error code to TAGID 8, and JOB sender to TAGID 9.

Data attribution 702 has one of the values of TYPEID that is defined by type definition list 820. Type definition list 820 is stored in HDD 202 of FIG. 2 and HDD 315 of FIG. 3.

For example, TYPEID 1 stands for a non-negative integer, TYPEID 2 for a signed integer, TYPEID 3 for a character string, TYPEID 4 for a real number, TYPEID 5 for a logical value, and TYPEID 6 for a complex number.

Data length 703 is described with byte numbers illustrating the each item of data that configures the job information. Offset value 704 describes the offset amount from the first value.

Accordingly, by configuring tag template 830, it is possible to include necessary information relating to a job and information allocation in tag template 830.

Also, the template is kept compact by using identifiers described in the list for the items within the tag definition list and type definition list.

Further, tag template 830 is provided as jobTagDef node 510 in MIB database 450 of printer 20. Accordingly, PC 10 can obtain tag template 830 from printer 20, by making a data obtaining request toward object ID 1.3.6.1.4.1.258.995.1 from description 610.

In addition, tag definition list 810 and type definition list 820 needs to be mutually accessible from PC 10 and printer 20. This is because PC 10 and printer 20 need to have the identical tag definition in order to accurately decode information.

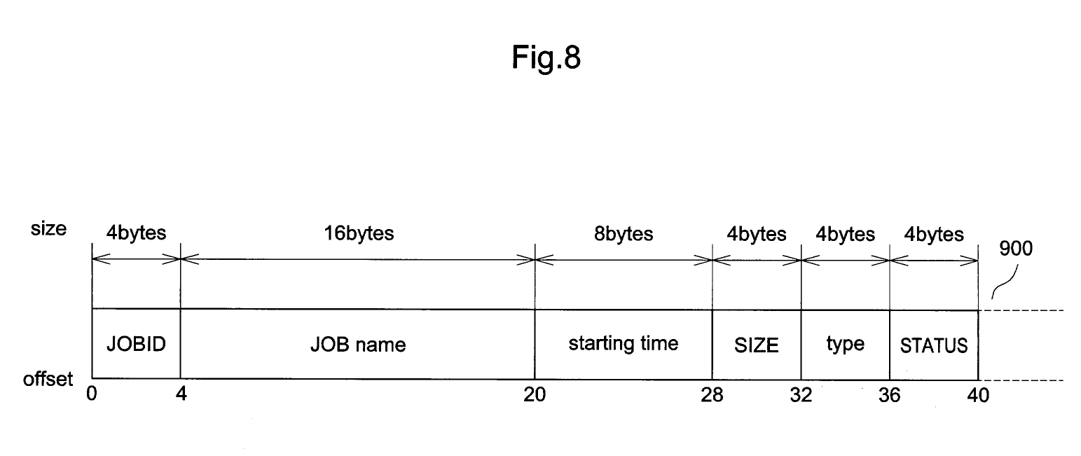

Next, FIG. 8 is used to illustrate a data structure that is generated based on the tag template according to the first embodiment. FIG. 8 illustrates the data structure that is generated based on the tag template according to the first embodiment.

Data structure 900 in FIG. 8 is generated based on tag template 803 of FIG. 7.

In FIG. 8, starting positions of elements of data structure 900 are illustrated when the first value is set to 0. These starting positions are written in to the offset value 704 shown in FIG. 7. Also, data illustrated as TAGID 701, Data attribution 702, and data length 703 is described a long with offset value 704. In the example of FIG. 8, job name has offset value 4, starting time has offset value 20, job size has offset value 28, job type has offset value 32, and job status has offset value 36.

As shown in description 630, jobData node 530, which is a body of job data, is provided as a byte string. By matching with data structure 900, the data encoded with the byte string can be decoded.

In addition, although data structure object 700 includes offset value 704 in the first embodiment, data structure object 700 is not required to include offset value 704. In such a case, an offset value can be calculated from data length 703.

Furthermore, data structure 900 is provided in MIB database 450 of printer 20 as jobData node 530. As illustrated in FIG. 5, the object of jobData node 530 can be obtained from printer 20, by making a request toward object ID 1.3.6.1.4.1.258.995.2.1.2.

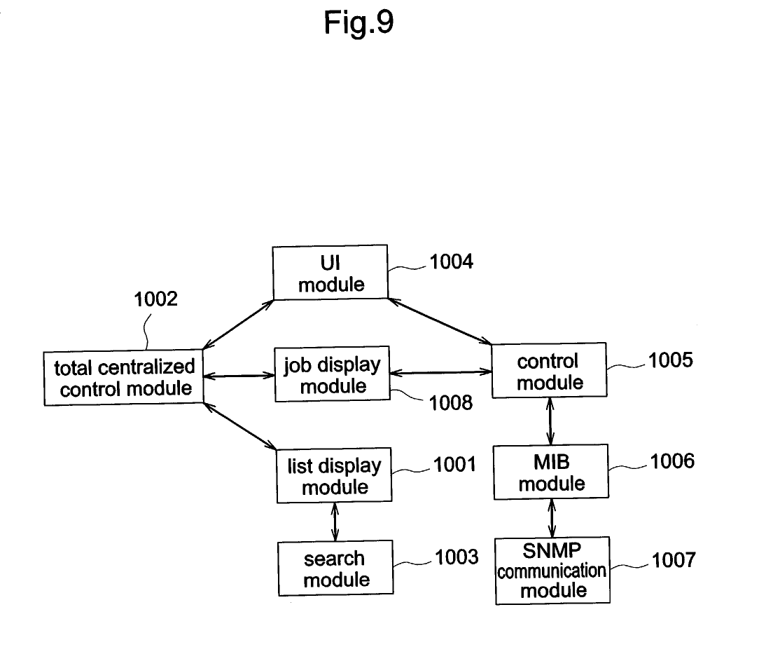

Next, an apparatus management process of a PC according to the first embodiment is illustrated. FIG. 9 is used to illustrate the configuration of apparatus management software (manager) executed by the PC. FIG. 9 illustrates a module configuration of the apparatus management software according to the first embodiment.

The apparatus management software according to the first embodiment is stored in hard disk 202 of FIG. 2 and executed by CPU 201a. During the execution, CPU 201a uses RAM 201c as a work area.

As shown in FIG. 9, list display module 1001 displays a list of printers 20a, 20b, etc., that are connected to communication medium 30. Total centralized control module 1002 controls other modules based on instructions from list display module 1001.

Search module 1003 searches for printers that are connected to communication medium 30. Printers searched by search module 1003 are displayed as a list, by list display module 1001. For example, a broadcasting method of SNMP message that is employed by existing apparatus management software (e.g., “JetAdmin” of HP, “NetSpot” of CANON) can be used as a method for searching printers.

UI (User Interface) module 1004 displays a detailed printer information window, which is later described. Job display module 1008 displays a job display window, which is also described later.

Control module 1005 is in charge of controlling printers. Control module 1005 obtains MIB data from printers 20a and 20b, using later-described MIB module 1006, converts data if necessary, and delivers the data to UI module 1005 and job display module 1008.

MIB module 1006 encodes a request toward an object ID using the SNMP, transmits the data to printer 20 on communication medium 30, via communication module 1007, and decodes SNMP data received form printer 20 on communication medium 30 to retrieve the data.

Next, an operation of the apparatus management system using the apparatus management software of FIG. 9 is illustrated.

As described above, when the management software of the PC side starts up, user can select a printer from a network apparatus list. After a printer is selected and a job management screen is shown, the management software specifies an object ID to the printer to make a request for obtaining a data structure list object. When the printer receives the request, the printer transmits a corresponding data structure list object as an SNMP response. Upon receiving the response, the management software extends the data structure list in RAM.

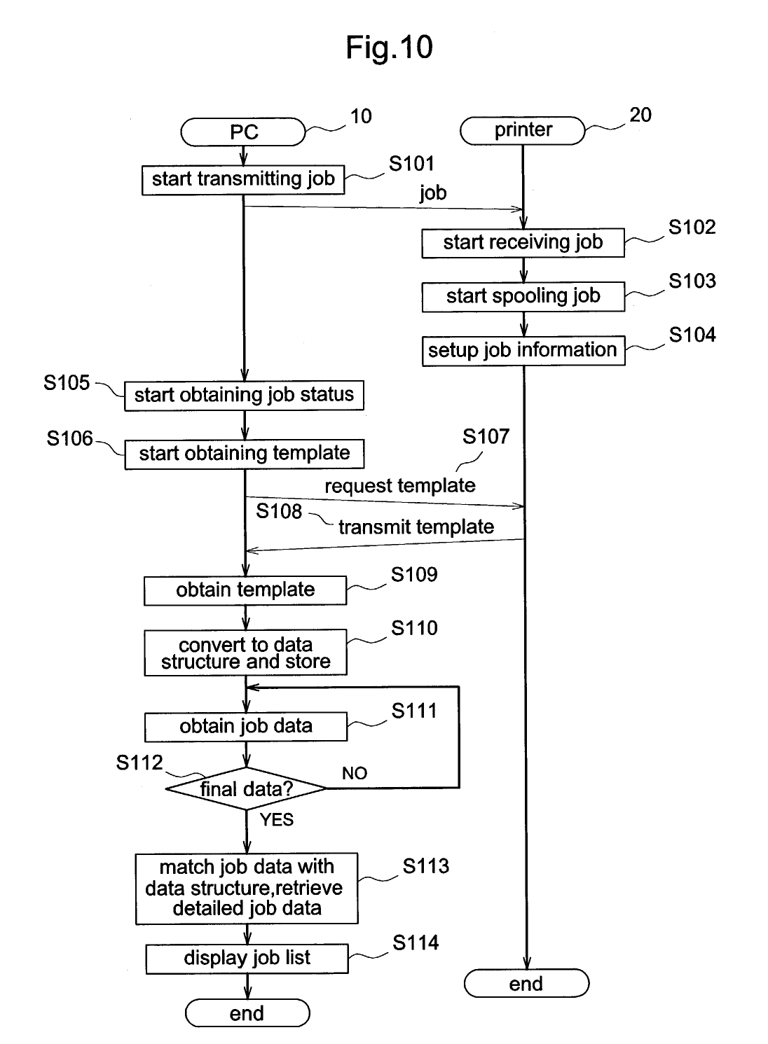

Hereafter, FIG. 10 is used to illustrate in detail the operation of the apparatus management system using the apparatus management software. FIG. 10 is a sequence chart illustrating the operation of the apparatus management system according to the first embodiment.

First, PC 10 (client computer) starts a transmission of a print job to printer 20 (S101).

Printer 20 starts receiving the print job sent from PC 10, at packet transmitter/receiver 411 (S102). Then, data generator 413 of printer 20 rebuilds data from the packet from the print job, which is received by packet transmitter/receiver 411, and transmits the data to data determiner 414. Since the transmitted data is a print request, data determiner 414 transmits the received job request data to print executer 470.

Print executer 470 adds a job ID to the received print job and spool the job (S103). In particular, print executer 470 adds a different job ID, which is different from already spooled jobs, to manage the job. The job management table includes data such as user name, job size, and job starting time, which are jointly managed (S104).

Next, control module 1005 of PC 10 starts obtaining job status information from printer 20, using SNMP communication module 1007 and MIB module 1006 (S105).

First, control module 1005 starts making a request to obtain tag template 830, which is expressed by jobTagDef node 510, from printer 20 (S106), using GETREQUEST of SNMP (S107). In response, printer 20 transmits the tag template to PC 10, using GETRESPONSE (S108). Then, PC 10 obtains the actual data of the tag template that is included in GETRESPONSE from printer 20 (S109), converts the data into a data structure, and store the same in RAM 201c (S110).

Next, control module 1005 accesses the spooled job information, which is managed by print executer 470 of printer 20, using GET or GETNEXT request of SNMP (expressed by jobData 530), and obtains each job information through a GETRESPONSE from printer 20 (S111). When all job information is obtained (S112), control module 1005 retrieves the data structure stored in RAM 201c, and matches the structure with the job information, in order to decode the received job information (S113).

Upon completing decoding of the job information, control module 1005 transmits the decoded job information to job display module 1008, and job display module 1008 displays the job information on a screen (S114).

According to the first embodiment, tag template 803, which is an item list of management information and describes an encoding method, and data structure 900, which is the actual data of job information (management information), are separately maintained. When PC 10 (manager) accesses printer 20 (agent) using an individual object ID, printer 20 can transmit the encoded job information to PC 10 with the encoding method described in tag template 830. Accordingly, all of the detailed job information within the table can be processed with one SNMP request/response, without of changing the framework of the conventional SNMP apparatus management. Therefore, it is possible to provide a highly responsive management system.

Additionally, according to the first embodiment, by separately maintaining the item list and actual data, it is possible to generate the actual data according to the item list, thereby improving the maintenance of management system.

Further, according to the first embodiment, tag definition list 810 and type definition list 820 are pre-defined between PC 10 and printer 20. Therefore, even if tag template 830 needs to be changed because of the change in the encoding method, tag template 830 can be changed within the range of tag definition list 810 and type definition list 820, so that PC 10 can analyze the changed tag template 830.

In addition, in the first embodiment, PC 10 is used as the apparatus management apparatus, and printer 20, as the management information transmission apparatus. However, it is needless to say that other apparatuses, which perform communications using the SNMP protocol, can be employed as the apparatus management apparatus and apparatus information transmission apparatus, to obtain the same effect.

Furthermore, in the above-described embodiment, printer 20 writes the job data using the encoding method written in the tag template. However, the same effect can be obtained where job data can be written using an original method, and the data can be converted into the tag template encoding method and transmitted, when PC 10 makes GETREQUEST according to the SNMP.

Second Embodiment

The second embodiment of the present invention adds version information to a tag template. Since a PC can obtain a tag template and its version information from a printer, the version information is checked upon obtaining the tag template. Therefore, it is possible to convert a data structure of the obtained template only when the version information is different from the version information of an already stored tag template.

Accordingly, it is possible to skip the process of data structure conversion of the tag template, as long as the printer's tag template is not updated and version information remains unchanged. Similarly, in case of having the same type of printer that has the same template on the same network, the data structure conversion process of a tag template for the each printer can be omitted.

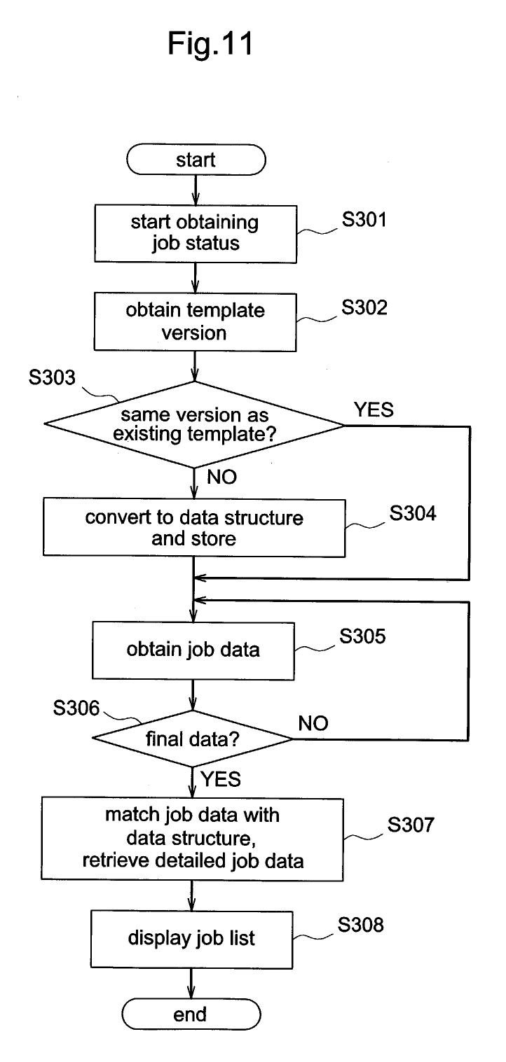

Next, FIG. 11 is used to illustrate the apparatus management system according to the second embodiment. FIG. 11 is a flowchart illustrating a process of a PC according to the second embodiment. FIG. 11 is a flowchart illustrating a process after PC 10 transmits a print job to printer 20.

Control module 1005 of PC 10 makes a request, by employing SNMP communication module 1007 and MIB module 1006, to obtain tag template 830, which is described by jobTagDef node 510 from printer 20, using GET request according to the SNMP, then starts obtaining the actual data of the tag template that is included in GETRESPONSE from printer 20 (S301).

In this illustration, control module 1005 has already obtained and stored tag template 830 from printer 20 at this stage. Also, tag template 830 received by control module 1005 includes the version of the tag template, and the version information has been stored.

Control module 1005 obtains the version of the tag template that is currently used by printer 20 (S302). The information related to the tag template version is described in a header of the tag template in this embodiment.

Next, control module 1005 compares the tag template version that already exists in PC 10 and the tag template version that is just obtained from this communication (S303). When the versions are different, the data structure is updated with the currently obtained tag template and stored in RAM 201c (S304).

Then, control module 1005 accesses the spooled job information managed by print executer 470 of printer 20, which is described with jobData 530, by using GET or GETNEXT request of SNMP. When printer 20 sends GETRESPONSE, job information for each apparatus is obtained (S305). When all job information is obtained (S306), control module 1005 retrieves the data structure that is stored in RAM 201c to match the structure with the data information, and decodes the received job information (S307).

When the decoding of the job information is completed, control module 1005 transmits the decoded job information to job display module 1008, so that job display module 1008 displays the job information on the screen (S308).

According to the second embodiment, it is possible to skip the process of data structure conversion of the tag template, as long as the printer's tag template is not updated and version information remains unchanged. Therefore, the entire process becomes more efficient. Similarly, in case of having the same type of printer that has the identical template on the same network, the data structure conversion process for the each printer template can be omitted.

In the second embodiment, tag template includes the version information. However, the version information can be recorded in a separate object of MIB, and the separate object can be referred when checking its version.

Third Embodiment

In the third embodiment of the present invention, the system includes a printer having a function that spools a job on a built-in hard disk. Thus, a PC controls the spooled job using the SNMP protocol.

Normally, upon receiving a job, a printer enters the job in a print waiting list to manage the job until it is printed. The job is first added at the end of the waiting list to wait for the print execution. When the job reaches the top of the waiting list, the job is printed. When the printing is complete, the job is deleted from the waiting list. Recently, according to the increase in the hard disk capacity, the number of jobs (that can be spooled) to be entered in the print waiting list has increased. Thus, there is also an increasing need to control a job in the waiting list from a PC, such as deleting and prioritizing the job. Detailed added job information relating the job, such as job ID, job name, and job entered time, needs to be included in the job, in order to specify the job in the waiting list and provide the job control from the PC. When the job information is configured as a table and detailed job elements are provided by individual MIBs, the item number is increased. Therefore, even if one unit of job information is obtained from the PC, the PC and printer must perform a series of information exchanges. The third embodiment addresses the above-described problem and provides a system where encoded data and method is exchanged between the PC and printer, so that one unit of job control information can be obtained in one communication cycle.

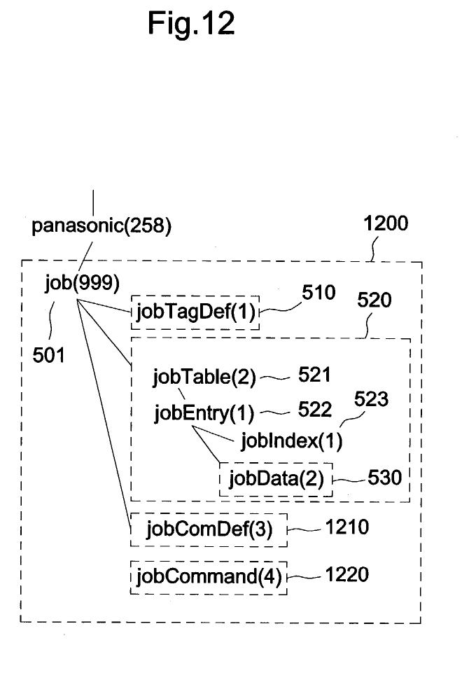

Hereafter, an apparatus management system according to the third embodiment is illustrated. First, FIG. 12 is used to illustrate an MIB database structure that is provided by a printer according to the third embodiment. FIG. 12 illustrates the MIB database structure that is provided by a printer according to the third embodiment. FIG. 12 illustrates the structure of the MIB database of FIG. 5, below the private MIB. Parts having the same numerical characters represent the same structure; therefore such illustration is omitted.

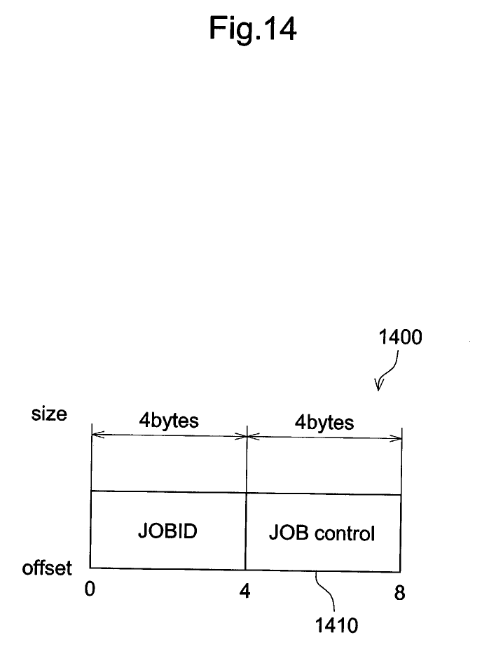

The MIB database according to the third embodiment includes an added parallel structure of template for job control command description (jobComDef) 1210 and job control command description object 1220, below JOB node 501 of private MIB 1200. Job control command description object (jobCommand) 1220 includes a content expressed by template for job control command description 1330 (the actual data is later-described data structure 1400 of FIG. 14). Job control 1410 has five categories: stop, hold, restart, delete, and prioritize, which are expressed by numbers 1-5 respectively.

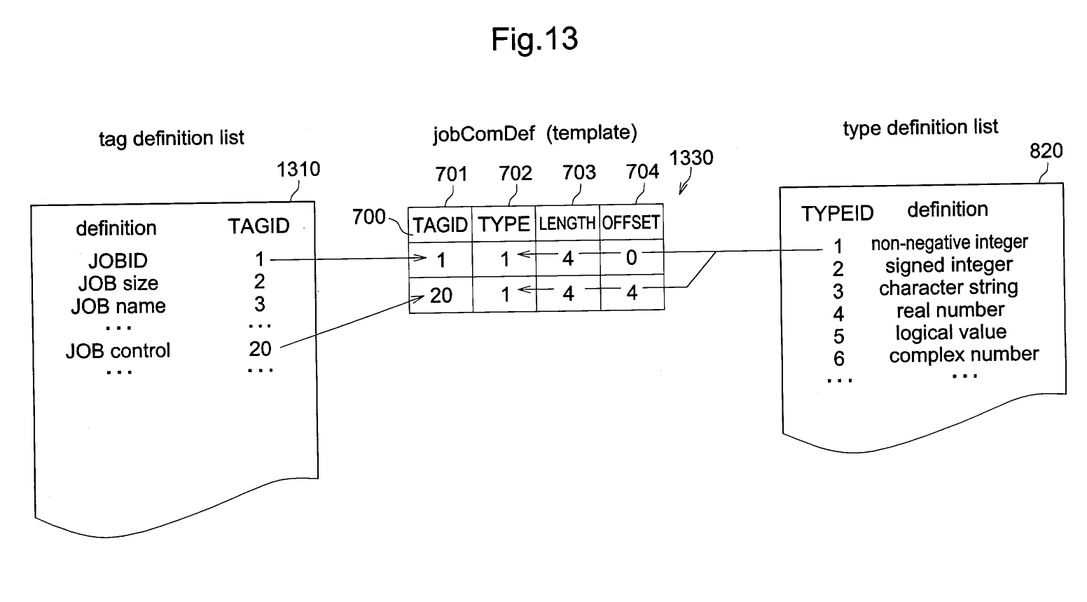

Next, FIG. 13 is used to illustrate a template for job control command description. FIG. 13 illustrates the template for job control command description according to the third embodiment.

Template for job control command description (jobComDef) 1330 is defined as a set of data structure object 700, similar to JobTagDef 830 illustrated in the first embodiment. Data structure object 700 is a set of data structure list having a fixed length format, each having 32 byte, configured with data tag number 701, data attribution 702, data length 703, and offset amount (from the front value) 704.

Data tag number 701 has one value of tag IDs defined in tag definition list 1310.

Tag definition list 1310 is a table that associates TAGID with an item related to the job information. Tag definition list 1310 is different from tag definition list 810 of the first embodiment in that tag definition list 1310 assigns job control to TAGID number 20. By assigning job control to TAGID number 20, template 1330 can describe the job control.

Similar to the first embodiment, data attribution 702 has one value of TYPEID that is defined by type definition list 820.

Since data length 703 and offset value 704 are the same items as in the first embodiment, therefore the detailed illustration is omitted.

Also, tag template 1330 is provided in the MIB database of printer 20, as jobComDef node 1210. Therefore, PC 10 can obtain tag template 1330 from printer 20, by making a request toward object ID 1.3.6.1.4.1.258.999.3.

Next, FIG. 14 is used to illustrate a data structure that is generated based on the tag template according to the third embodiment. FIG. 14 illustrates the data structure that is generated based on the tag template according to the third embodiment.

Data structure 1400 in FIG. 14 is generated based no tag template 1330 of FIG. 13.

In FIG. 14, the starting value of each element that configures data structure 1400 is included, having the first value set to 0. These starting values are written in the position of offset value 704 of FIG. 13. In the example of FIG. 14, JOBID (name) is described at offset value 0, and job control is described at offset value 4.

Job control has five categories: stop, hold, restart, delete, and prioritize, which are expressed by numbers 1-5 respectively. By describing number 1-5 at the starting value 4 of data structure 1400, a job control: stop, hold, restart, delete, or prioritize can be performed.

Also, data structure 1400 is provided in MIB database 450 of printer 20, as jobData node 530. This object can be obtained from PC 10 by requesting toward object ID 1.3.6.1.4.1.258.999.2.1.2.

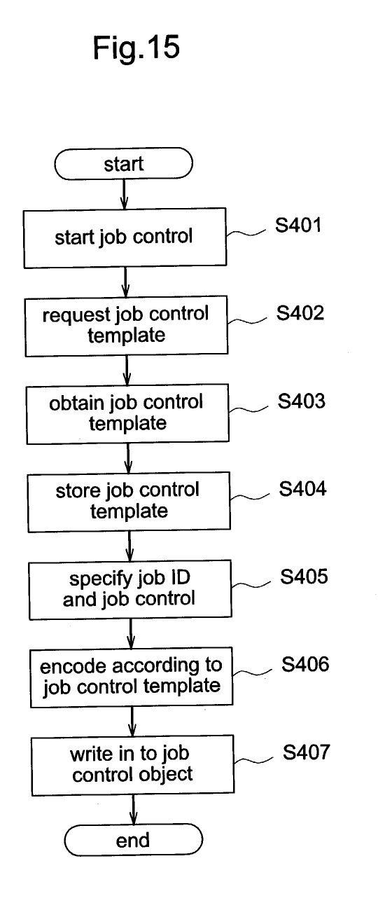

Next, FIG. 15 is used to illustrate in detail, an operation of the apparatus management system according to the third embodiment of the invention. FIG. 15 is a flowchart illustrating the operation of a PC in the apparatus management system according to the third embodiment. The configuration of apparatus management software executed by PC 10 is the same as in the first embodiment; therefore a detailed illustration is omitted.

When PC 10 starts a job control (S401), control module 1005 of PC 10 uses SNMP control module 1007 and MIB module 1006 and requests a transmission of template for job control 1330 from printer 20 (S402). Then, control module 1005 of PC 10 obtains template for job control 1330, which is an MIB data structure, transmitted from printer 20 via SNMP communication module 1007 and MIB module 1006 (S403), and template 1330 obtained at S403 is stored in RAM 201c (S404).

Next, control module 1005 specifies the job ID of the job to be controlled and the content of the control (S405). Next, control module 1005 encodes the job ID and job control (specified at S405) according to template 1330 obtained at S403 (S406). Then, control module 105 transmits the encoded job information to printer 20 using SET REQUEST, and writes in the job control to the job control object of printer 20 (S407).

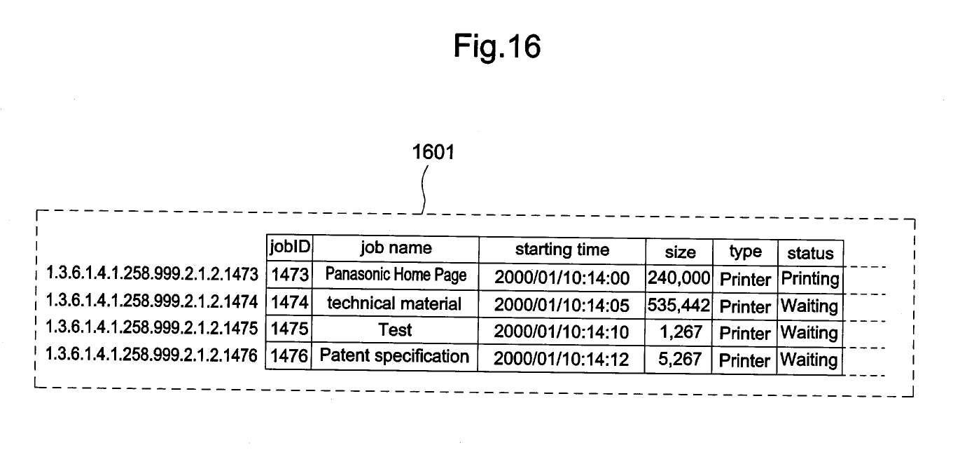

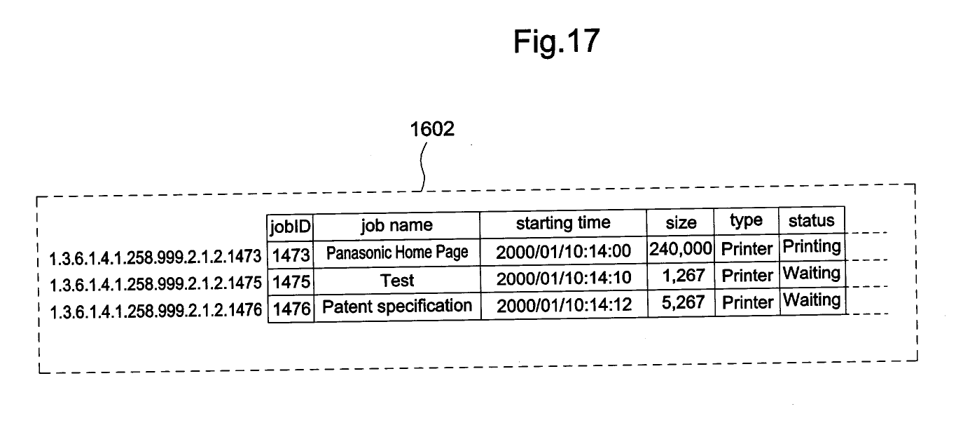

For example, job list 1601 has job IDs 1473-1476 as shown in FIG. 16. When PC 10 chooses Job ID 1474 and “2” (delete) for job control information, encodes the data based on the template, and transmits the same to printer 20, job list 1602 as shown in FIG. 17 can be created, which deletes the job of job ID 1474 from job list 1601. FIGS. 16 and 17 illustrate a job list according to the third embodiment.

As described above, according to the third embodiment, when PC 10 transmits job ID and job control information to printer 20, a predetermined control can be performed to a job stored in the HDD.

Also, according to the third embodiment, PC 10 encodes the job ID and job control information according to the template and transmits the data to printer 20, so that printer 20 can analyze the encoded information based on the template. Accordingly, PC 10 can transmit a plurality of items, i.e., job ID and job control information, to printer 20, in one communication cycle. Therefore, the communication load between PC 10 and printer 20 can be lightened.

In the third embodiment, there are five categories for the job controls. However, it is needless to say that the same effect can be obtained when there are different numbers of categories, or other controls are defined for the categories.

Also, in the third embodiment, numerical characters are applied to the command definition of the job control. However, a character string can be applied such as “DELETE” for deleting the job.

Also, security information can be included in the job control information, such as user name and password, so that a job control by a malicious user can be prohibited.

Fourth Embodiment

In the fourth embodiment of the present invention, a PC uses a TRAP message transmission to a printer. When the printer completes an object writing operation, the printer informs the PC whether the object writing operation is correctly performed. Accordingly, the PC can confirm whether the object writing operation is correctly performed.

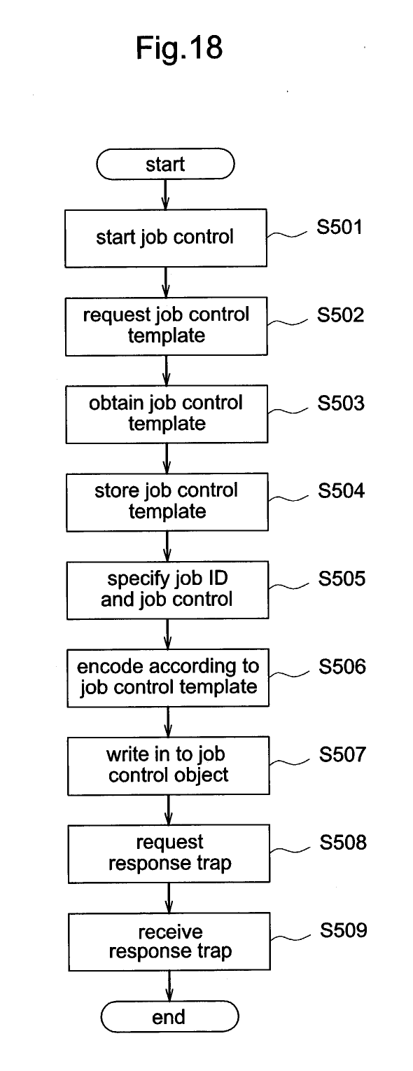

Hereafter, FIG. 18 is used to illustrate the operation of the apparatus management system according to the fourth embodiment. FIG. 18 is a flowchart illustrating the operation of a PC in the apparatus management system according to the fourth embodiment.

When PC 10 starts a job control (S501), control module 1005 of PC 10 uses SNMP communication module 1007 and MIB module 1006 and requests a transmission of template for job control 1330 from printer 20 (S502). Then, control module 1005 of PC 10 obtains template for job control 1330, which is an MIB data structure, transmitted from printer 20 via SNMP communication module 1007 and MIB module 1006 (S503), and stores the template 1330 obtained at S503 in RAM 201c (S504).

Next, control module 1005 specifies the job ID for the job to be controlled and content of the control (job control information) (S505).

At this time, control module 1005 writes in to the job control information, its own address (of PC 10) as a return address for printer 20 to inform whether the object has been correctly written.

Next, control module 1005 encodes the job ID and job control (specified at S505) according to template 1330 obtained at S503 (S506). Then, control module 1005 transmits the encoded job control information to printer 20 by using SET of SNMP, in order to write in the job control to the job control object at printer 20 (S507). Since the job control content that is written in at S507 includes the address of PC 10 as a return address to inform whether the object has been correctly written, printer 20 transmits a TRAP message to PC 10 (S508).

Then, the control module 1005 receives the response (TRAP) from printer 20 (S509). According to the fourth embodiment, printer 20 transmits a TRAP message to PC 10, so that PC 10 can receive a response indicating whether printer 20 has correctly written the object. Therefore, PC 10 can determine whether printer 20 has correctly written the object.

Also, in the fourth embodiment, the return address for information indicating whether the object has been correctly written is encoded as a data structure based on the template, and transmitted, together with the control content. Therefore, it is possible to lighten the communication load.

In addition, the fourth embodiment uses a standard TRAP message to notify the process completion in response to the instruction from the PC. However, the same effect can be obtained when other network protocol and communication method is used.

Fifth Embodiment

The fifth embodiment of the present invention provides a system including a printer that has a function to store log data (e.g., print log and operation log) in a built-in hard disk, the system controlling the stored log from a PC using the SNMP protocol.

When a simple MIB structure is provided having a log as a table and each element of a log as a node, a number of items need to be included in one log. In order for a PC to obtain one unit of log information (the entire elements within one table), the PC is required to communicate with a printer to obtain individual element using the SNMP protocol. Normally, a plurality of log information units are stored in the printer, thereby increasing the communication overhead. Accordingly, in order to address the above-described problem, the fifth embodiment provides a communication of encoded log and template describing an encoding method between a PC and printer, so that one entire log can be obtained in one communication cycle.

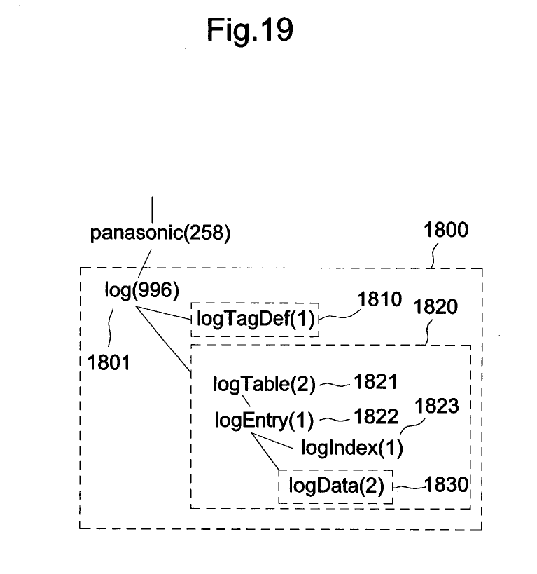

The following illustrates an apparatus management system according to the fifth embodiment. First, FIG. 19 is used to illustrate an MIB database structure provided by a printer according to the fifth embodiment. FIG. 19 illustrates the MIB database structure according to the fifth embodiment. FIG. 19 illustrates the structure of the MIB database of FIG. 5, starting from the private MIB. Parts having the same numerical characters represent the same structure; therefore such illustration is omitted.

The MIB database according to the fifth embodiment has a log node below private MIB 1800. Under log node 1801, template for log description 1810 and log table including log information 1820 are provided in parallel. Logtable 1820 includes logTable 1821, which defines logtable 1820, jobEntry 1822, which is an entry for logTable 1820, logIndex node 1823, which is an index of logTable 1820, and logData node 1830, which includes log information.

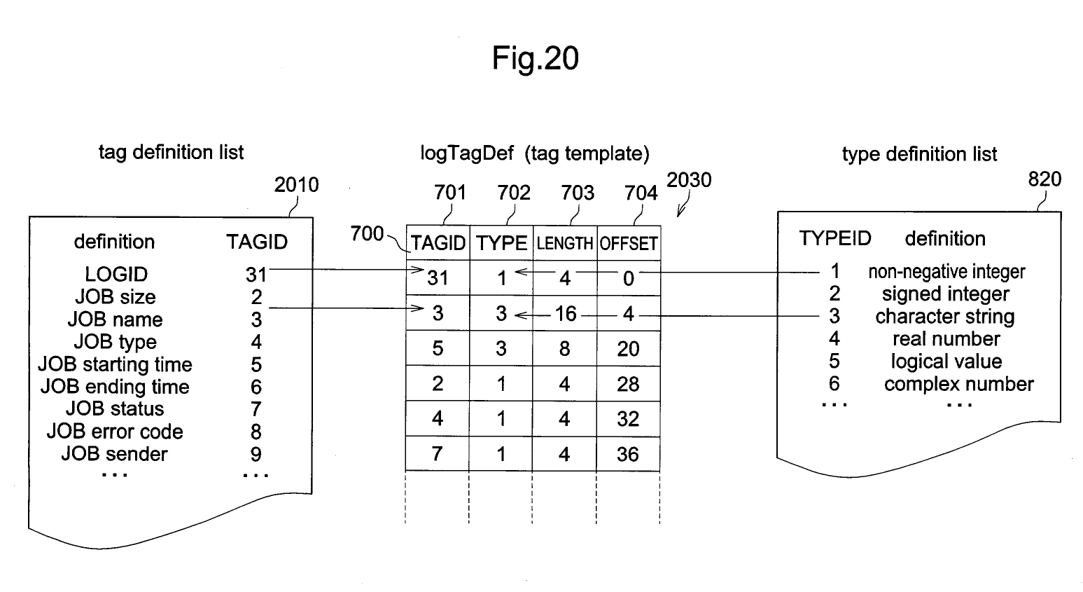

Next, FIG. 20 is used to illustrate the template for log description. FIG. 20 illustrates the template for log description according to the fifth embodiment.

Template for log description (logTagDef) 2030 is defined as a set of data structure object 700, similar to JobTagDef 830 illustrated in the first embodiment. Data structure object 700 is a set of data structure list having a fixed length format, each having 32 byte, and configured with data tag number 701, data attribution 702, data length 703, and offset amount (from the front value) 704.

Data tag number 701 has one value of tag IDs defined in tag definition list 1310.

Tag definition list 2010 is a table that associates TAGID with an item related to log information. Tag definition list 2010 is different from tag definition list 810 of the first embodiment in that tag definition list 2010 assigns LOGID to TAGID number 31. By assigning an LOGID to TAGID number 31, template 2030 can list the desired ID log.

Data attribution 702, data length 703, and offset value 704 are the same as described in the first embodiment; thus illustration of the same is omitted.

Also, tag template 2030 is provided in the MIB database of printer 20, as jobTagDef node 1810. Therefore, PC 10 can obtain tag template 2030 by requesting toward object ID 1.3.6.1.4.1.258.996.1.

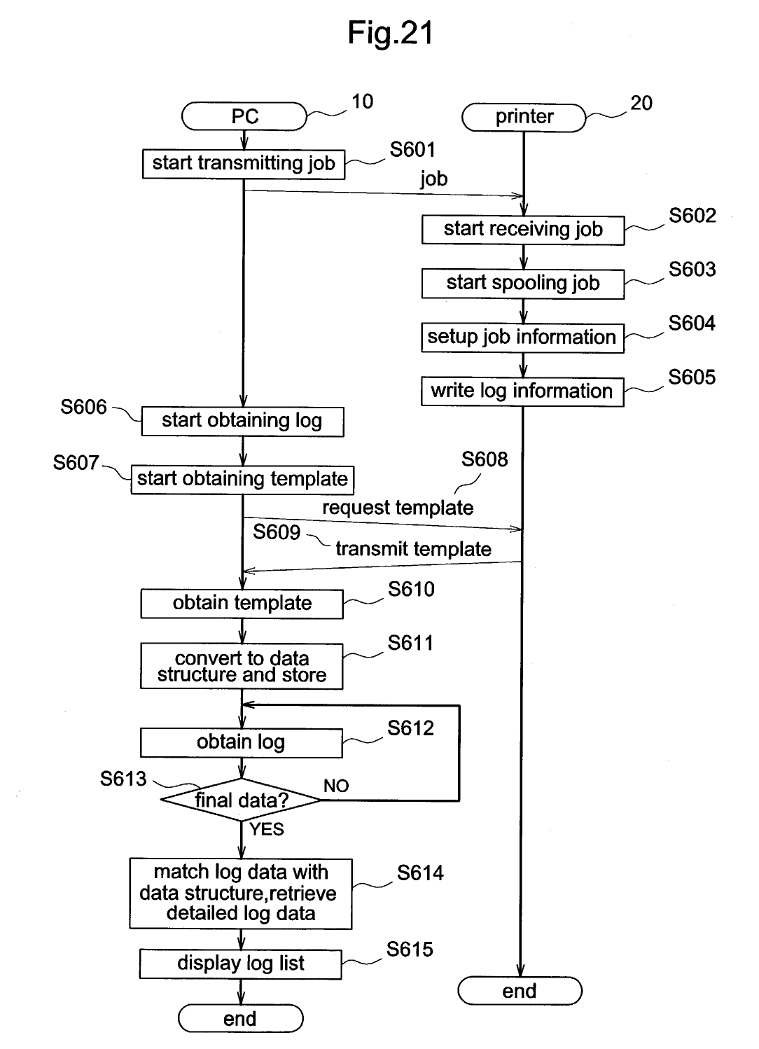

Hereafter, an operation of the apparatus management system employing the apparatus management software is illustrated in detail using FIG. 21. FIG. 21 is a sequence chart illustrating the operation of the apparatus management system according to the fifth embodiment.

PC 10 (client computer) starts transmitting a print job to printer 20 (S601).

Printer 20 starts receiving the print job that is transmitted from PC 10, at packet transmitter/receiver 411 (S602). Then, data generator 413 of printer 20 rebuilds the data from a packet of the print job, which is received by packet transmitter/receiver 411, and transmits the data to data determiner 414. Since the transmitted data is a print request, data determiner 414 transmits the received job requesting data to print executer 470.

Print executer 470 adds a job ID to the received print job and spool the job (S603). In particular, print executer 470 adds a different job ID, which is different from already spooled jobs, to manage the job. The job management table includes data such as user name, job size, and job starting time, which are jointly managed (S604).

Upon completing the above job, i.e., when print mechanism 330 completes the print job, print executer 470 deletes the job data from the job management table and writes out a log information of the completed print job, including the user name, job size, job starting time, job ending time, consumed number of pages, number of printed surfaces, on the log management table of HDD 315 (S605). At this time, print executer 470 encodes the job information according to tag template 830 and writes in the same to data structure 900.

Then, MIB module 1006 of PC 10 (client computer) starts obtaining the log information (S606).

First, control module 1005 starts making a request to obtain tag template 2030 from printer 20 (S607), by encoding (creating a packet from) an object ID that corresponds to the requested template for log description 2030 by SNMP, and by transmitting GET request of SNMP to printer 20 via communication module 1007 (S608). Then, printer 20 transmits the template with GETRESPONSE to PC 10 in response (S609). Control module 1005 of PC 10 obtains tag template 2030 from the GETRESPONSE message of SNMP, which is returned from printer 20 (S610), and stores the data in RAM 201c after converting it into a data structure (S611).

Control module 1005 of PC 10 then accesses log information 1830 managed by printer 20, using SNMP communication module 1007 and MIB module 1006 with GET or GETNEXT request of SNMP, and starts obtaining the log information through the GETRESPONSE from printer 20. When all log information is obtained (S613), control module 1005 retrieves the data structure stored in RAM 201c, and matches the structure with the log information, in order to decode the received log information (S614).

Upon completing decoding of log information, control module 1005 transmits the decoded log information to job display module 1008, so that job display module 1008 can display the log information on a screen (S615).

According to the fifth embodiment, tag template 2030, which is the item list of the log information and describes the encoding method, and actual data of the log information are separately maintained. When PC 10 (manager) accesses printer 20 (agent) with separate object IDs, PC 10 can obtain the log information that is encoded in the encoding method listed in tag template 2030, from printer 20.

Additionally, according to the fifth embodiment, tag template 2030, which is the item list and describes the encoding method, and encoded information (actual data of log information) are separately maintained. Therefore, it is possible to generate the actual data according to the item list, thereby improving the maintenance of the management program. In the fifth embodiment, printer 20 writes out the log data according to the encoding method of the tag template. However, a similar effect can be obtained where printer 20 first uses an original method for the encoding, and then converts into the encoding method of the tag template when PC 10 transmits a GETREQEUST of SNMP, in order to transmit the data.

Sixth Embodiment

The sixth embodiment of the present invention is a extended variation of the fifth embodiment. In particular, the sixth embodiment focuses on an issue that printer can store only a certain number of logs because of limitations such as its memory and HDD size. In other words, during a log retrieval that uses the SNMP, logs are normally collected from a printer at a predetermined time interval. When the time interval is inappropriately large, there is a possibility that a PC (manger) may lose some logs that are provided by the printer (agent).

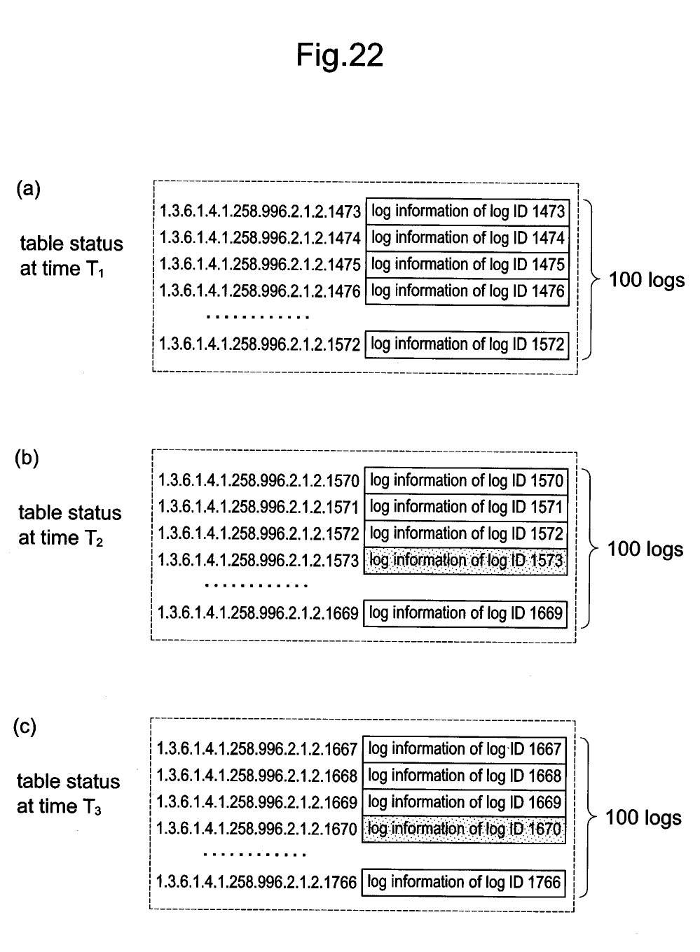

Hereafter, FIGS. 22(a)-22(c) are used to illustrate losing of logs. FIG. 22(a) illustrates the list of logs stored by the apparatus to be managed at time T1. FIG. 22(b) illustrates the list of logs stored by the apparatus to be managed at time T2 (=T1+α, T2>T1). FIG. 22(c) illustrates the list of logs stored by the apparatus to be managed at time T3 (=T2+α, T3>T2). α(>0) illustrates a time interval for the log retrieval.

As shown in FIG. 22(a), log numbers 1473-1572 are stored at time T1, while log numbers 1570-1669 are stored at time T2 (=T1+α, T2>T1) as shown in FIG. 22(b), and log numbers 1667-1766 are stored at time T3 (=T2+α, T3>T2) as shown in FIG. 22(c). Accordingly, one hundred logs are stored in the sixth embodiment.

When a ring buffer is used for the memory to store the logs, for example, log number 1573 replaces log number 1473 when transiting from T1 to T2. Similarly, when an older log is replaced with a newly log in the order of time, the content of the log management table transits from FIG. 22(b) to FIG. 22(c).

However, when the maximum number of logs to be stored is small, it is likely that some logs may be lost without accessing the log table with a smaller time interval for the log retrieval. Accordingly, the PC needs to have an appropriate value of α; however, it is difficult to determine the appropriate time interval for the log retrieval.

When a is chosen for the retrieval interval by the manager for the example of FIGS. 22(a)-22(c), the logs will not be lost. However, when 2α is chosen (collecting the logs at T1 and T3, but not at T2), log numbers 1573-1666 will be lost.

Accordingly, in the sixth embodiment, a printer is provided with a number of storable logs in an MIB database, so that a PC can obtain the number of storable logs from the MIB database in the printer. Therefore, the PC can retrieve the logs at an appropriate time interval.

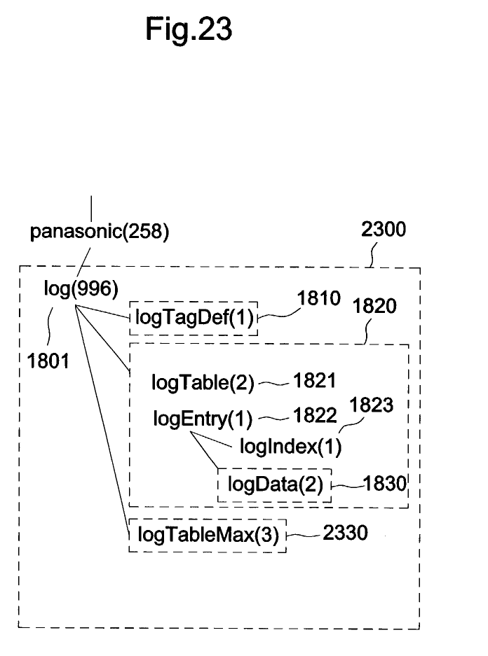

Next, FIG. 23 is used to illustrate in detail the MIB database of the printer. FIG. 23 illustrates an MIB database structure according to the sixth embodiment. Parts having the same numerical characters represent the same structure; therefore such illustration is omitted.

The MIB database according to the sixth embodiment has a log node below private MIB 2300. Further, template for log description 1810, table including log information logTable 1820, and logTableMax 2330 that illustrates the number of stored log, are provided in parallel, below log node 1801.

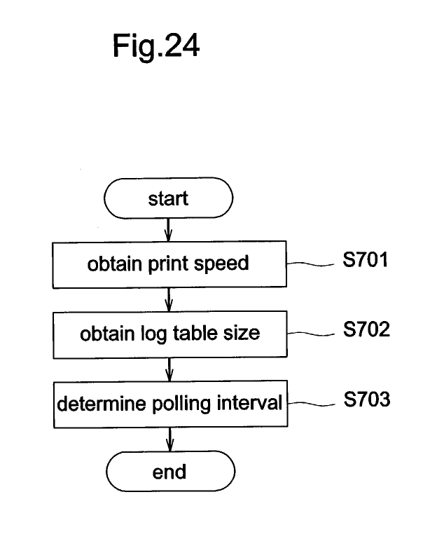

Next, FIG. 24 is used to illustrate an operation of the PC (manager) to set up a polling interval according to the sixth embodiment. FIG. 24 is an operational flowchart illustrating the operation of the PC to set up the polling interval according to the sixth embodiment.

When PC 10 starts setting a polling interval, the printing speed is obtained first (S701). PC 10 can obtain the printing speed from a standard printer MIB.

Then, PC 10 obtains a log table size (S702). The log table size can be obtained by making a request toward object ID 1.3.6.1.4.1.258.996.3.

Then, PC 10 determines the polling interval (S703). Since the inverse number of the printing speed is a printing time per one sheet of paper, the polling time is determined by multiplying the inverse number of printing speed with the table size. For example, when a printer can print 50 pages per minute having 100 table size, polling time is calculated as follows: 1/50×100=2 minutes. Normally, printing speed of a printer does not include speed-lowering factors such as operations for downloading/expanding font data, job process, etc. Therefore, it is impossible to process the same number of jobs (50 jobs/minute) with the printing speed (50 pages/minute), thus decreasing the number of jobs that can be processed. Therefore, the above-calculated value is appropriate for the polling interval.

As illustrated above, according to the sixth embodiment, it is possible to set an appropriate polling interval, thereby preventing to lose some logs during the log retrieval.

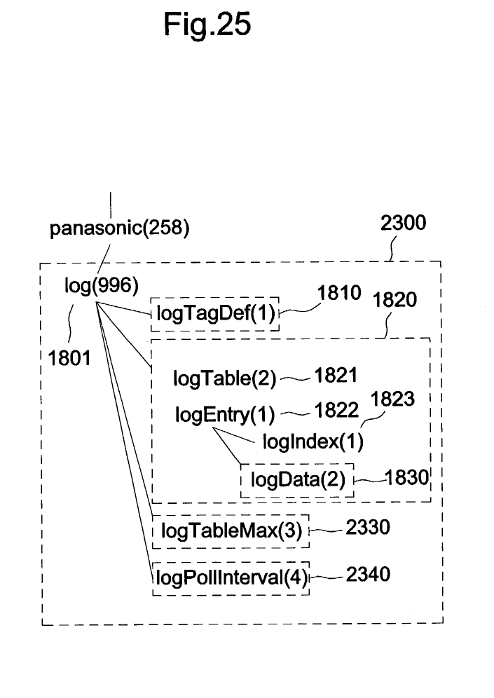

In the sixth embodiment, PC 10 determines a polling interval. However, printer 20 (agent) can include logpollInterval 2340 illustrating polling intervals as shown in FIG. 25. In this configuration, a PC can automatically obtain a polling interval from printer 20, without calculating from the printing speed and log table number. In this case, when printer 20 transmits the polling interval to PC 10, the communication becomes more effective. FIG. 25 illustrates another MIB database structure according to the sixth embodiment.

Seventh Embodiment

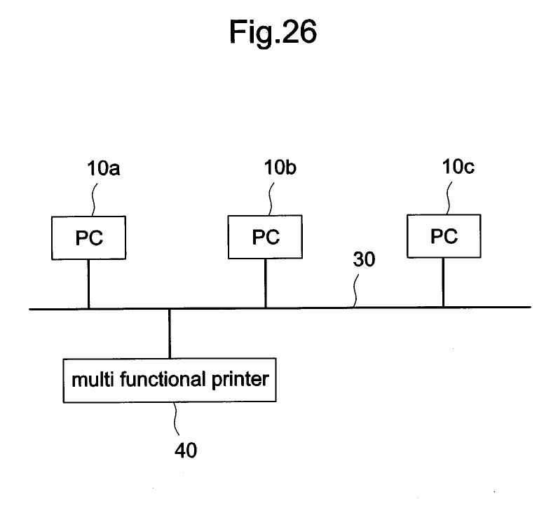

As shown in FIG. 26, the seventh embodiment of the present invention provides a system where a plurality of PCs 10a-10c, and multifunctional printer 40, which functions as a printer, facsimile, and copier, etc., are connected via network 30. FIG. 26 is a block diagram illustrating an apparatus management system according to the seventh embodiment.

In the system according to the seventh embodiment, a plurality of PCs 10a-10c use multifunctional printer 40 as a printer, and general user uses multifunctional printer 40 as a copier and/or facsimile machine. In this setting, an account management system is generally provided to monitor the users use of various services in multifunctional printer 40. Also, the manager of multifunctional printer 40 also registers a new user, changes user information, and deletes a registered user, in a narrow sense of so-called user management. In this embodiment, “user management” includes both the above mentioned account management and user management in a narrow sense.

In the system of the seventh embodiment, PC 10c (remote client terminal) performs the above described user management by the communication with multifunctional printer 40, using the SNMP.

However, since user management information is comprised of many items including user name, phone number, mail address and other various account information, PC 10 and multifunctional printer 40 are required to frequently exchange information, for each item stored as MIB, every time user information is controlled.

Therefore, in the seventh embodiment, a plurality of encoded detailed user management information and template describing the encoding method are exchanged between PC 10 and multifunctional printer 40. As a result, it is possible to transmit user management information for one person in one communication cycle.

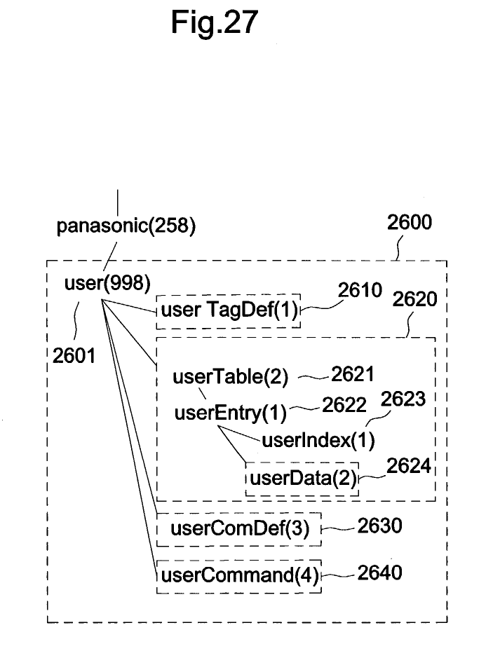

Hereafter, the apparatus management system according to the seventh embodiment is illustrated in detail. First, FIG. 27 is used to illustrate an MIB database structure provided in the multifunctional printer according to the seventh embodiment. FIG. 27 illustrates the MIB database structure according to the seventh embodiment. Parts having the same numerical characters represent the same structure; therefore such illustration is omitted.

The MIB database according to the seventh embodiment has user node 2601 below private MIB 2600. Further, template for user information description 2610, table including user information userTable 2620, template for user control command description 2630, and object for user control command description 2640 are provide in parallel under user node 2601.

Table including user information 2620 that includes user information is configured with userTable 2621, which defines table 2620, userEntry 2622, which is an entry for table 2620, userIndex node 2623, which is an index of table 2620, and userData node 2624, which includes user information.

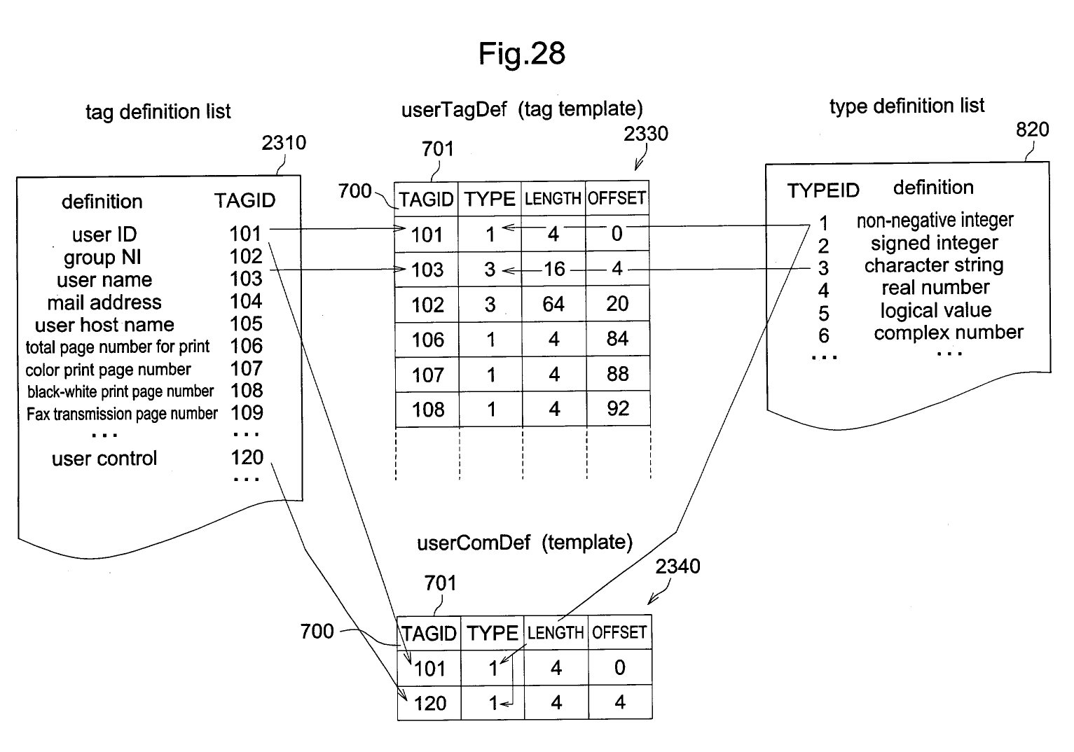

FIG. 28 is used to illustrate the template for user information description and template for user control command description. FIG. 28 illustrates the template for user information description and template for user control command description according to the seventh embodiment.

Template for user description (userTagDef) 2330 and template for user control command description (userComDef) 2340 are defined as a set of data structure object 700, similar to JobTagDef 830 illustrated in the first embodiment.

Data tag number 701 has one value of the tag IDs defined in tag definition list 2310.

Tag definition list 2310 is a table that associates items related to user information with TAGID. Tag definition list 2310 assigns user ID to TAGID 101, group ID to TAGID 102, user name to TAGID 103, user mail address to TAGID 104, user host name to TAGID 105, total number of pages that a user has printed using multifunctional printer 40 to TAGID 106, number of color print pages that user printed with color to TAGID 107, number of black-while pages that the user has printed with black-white to TAGID 108, number of fax transmission pages that the user has transmitted using multifunctional printer 40 to TAGID 109, and user control information that illustrates the control content of the user information logged in multifunctional printer 40 to TAGID 120.

Also, user control information (TAGID 120) is used at userComDef 2340.

In this embodiment, “0” in the user control information illustrates newly creating user information, “1” illustrates deleting user information, and “2” illustrates changing user information.

In addition, tag template 2330 is provided as userTagDef node 2610, and tag template 2340 is provided as userComDef node 2630 in the MIB database of printer 20. Accordingly, PC 10 can obtain tag template 2330 and tag template 2340 by making requests toward object ID 1.3.6.1.4.1.258.988.1 and object ID 1.3.6.1.4.1.258.998.3, respectively.

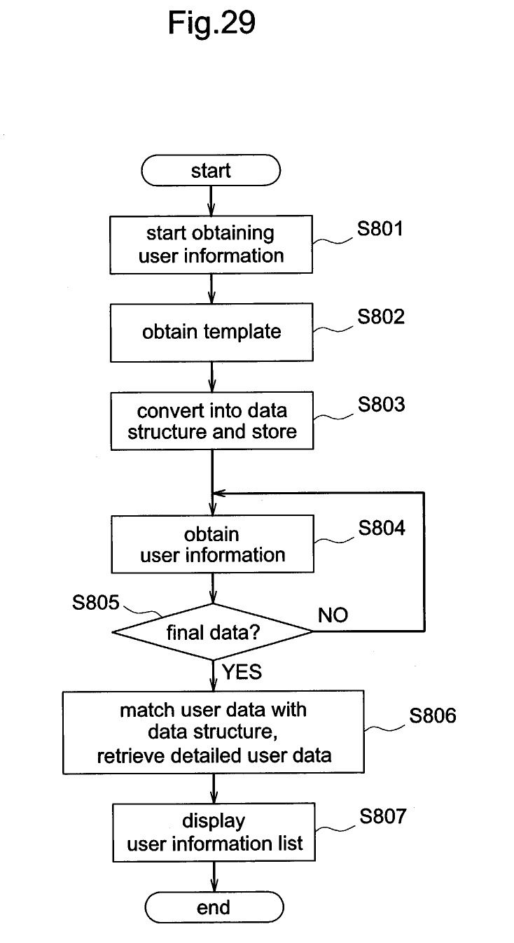

Next, FIG. 29 is used to illustrate an operation for obtaining user information in the apparatus management system according to the seventh embodiment. FIG. 29 is a flowchart illustrating the operation a PC to obtain user information according to the seventh embodiment.

Control module 1005 of PC 10 starts obtaining user information, which is an MIB data structure sent from multifunctional printer 40, using SNMP communication module 1007 and MIB module 1006 (S801).

First, control module 1005 obtains tag template 2330 from multifunctional printer 40 (S802), converts it into a data structure, and stores the same in RAM 201c (S803).

Then, control module 1005 accesses the user information within the transmitted data structure, and obtains the individual user information (S804). Upon obtaining all user information (S805), control module 1005 retrieves the data structure that is stored in RAM 201c to match the structure with the user information, and decodes the received user information (S806).

When the decoding of the job information is completed, control module 1005 transmits the decoded job information to job display module 1008, so that job display module 1008 displays the job information on the screen (S807).

Accordingly, tag template 2330, which is an item list and describes the encoding method, and user information, which is structuralized actual data, are separately maintained. By accessing the above data with separate object IDs, it is possible to process the entire data within a table win one SNMP request, without changing the framework of the conventional SNMP apparatus management, thereby providing a more responsive management system.

Moreover, according to the seventh embodiment, PC 10 can control the user information that is stored in multifunctional printer 40. When the communication is conventionally performed by simply using the SNMP, PC 10 is also required to transmit information multiple times, in case of having plurality of user information units to be controlled. Therefore, in the seventh embodiment, encoded control method for user information and encoding method are communicated between PC 10 and multifunctional printer 40, so that information related to controlling plurality of user information units are transmitted in one communication cycle.

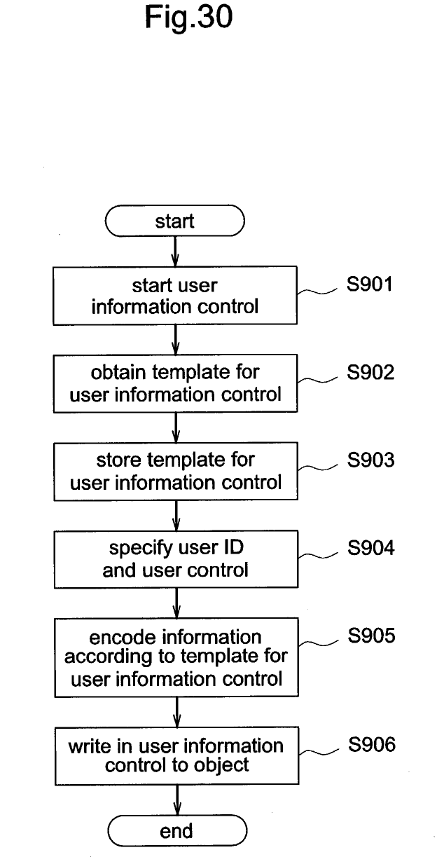

Hereafter, FIG. 30 is used to illustrate in detail, a user information control in the apparatus management system according to the seventh embodiment. FIG. 30 is a flowchart illustrating the user information control by a PC in the apparatus management system according to the seventh embodiment.

When PC 10 starts a user information control (S901), control module 1005 of PC 10 requests a transmission of template for user information control 2340 from multifunctional printer 40, using SNMP communication module 1007 and MIB module 1006 (S902). Then, control module 1005 of PC 10 obtains template for user information control 2340, which is an MIB data structure, from multifunctional printer 40, via SNMP communication module 1007 and MIB module 1006 (S903), and stores template 2340, which is obtained at S903 in RAM 201c (S904).

Next, control module 1005 specifies the user ID of user information to be controlled, and controlling contents, and encodes the specified user ID and user information control according to template 2340 that is obtained at S903 (S905).

Then, control module 1005 transmits the encoded information regarding the user information control to multifunctional printer 40 by SET of SNMP, so that user information control is written in to user information control object 2640 of multifunctional printer 40 (S906). Accordingly, multifunctional printer 40 can perform a user information control that is intended by PC 10, based on the control content and user ID information.

According to the seventh embodiment, since PC 10 transmits user ID and user control information to multifunctional printer 40, a predetermined control can be performed to the user information that is stored in a HDD.

Additionally, according to the seventh embodiment, PC 10 encodes the user ID and information regarding the user information control in accordance with the template, and transmits the same to multifunctional printer 40. Therefore, multifunctional printer 40 can analyze the encoded information based on the template. As a result, PC 10 can transmit the user ID and information regarding the user information control to multifunctional printer 40, in one communication cycle, even if there are a plurality of items that are conventionally provided as individual MIBs. Accordingly, it is possible to lighten the communication load between PC 10 and multifunctional printer 40.

In this embodiment, multifunctional printer 40 stores user information in the encoding method written in the tag template. However, it is possible to obtain the same effect where the user information is stored in an original method, and the information is converted into the encoding method of the tag template for transmission, upon receiving GETREQUEST of SNMP from PC 10.

Eighth Embodiment

The system according to the eighth embodiment of the present invention is illustrated in FIG. 26 as in the seventh embodiment.

In this system, multifunctional printer 40 uses a plurality of PCs 10a-10c. Also, multifunctional printer 40 is provided with a facsimile function and e-mail function. Accordingly, multifunctional printer 40 stores e-mail addresses and facsimile numbers for a plurality of users. In this embodiment, PC 10 communicates with multifunctional printer 40 using the SNMP, in order to obtain information relating to users such as e-mail addresses and facsimile numbers (hereafter referred to as “address management information”), to register new address management information, and to change or delete such information.

However, since there are many items that are involved in the address management information, a plurality of information exchanges are necessary between PC 10 and multifunctional printer 40, when the communication is performed simply using the SNMP.

Therefore, a plurality of address management information units are transmitted in one communication cycle, by communicating the encoded information of the plurality of address management and the encoding method between PC 10 and multifunctional printer 40.

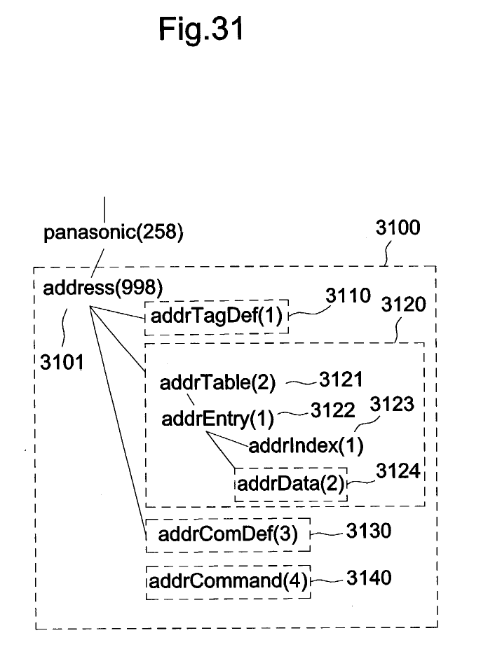

Hereafter, the apparatus management system according to the eighth embodiment is illustrated in detail. First, FIG. 31 is used to illustrate an MIB database structure that is provided in the multifunctional printer according to the eighth embodiment. FIG. 31 illustrates the MIB database structure according to the eighth embodiment. Parts having the same numerical characters represent the same structure; therefore such illustration is omitted.

The MIB database according to the eighth embodiment has address node 3101 below private MIB 3100. Further, template for address management information description (addrTagDef) 3110, table including address management information (addrTable) 3120, template for address management information control description 3130, and object for address management information control command description 3140 are provided in parallel below address node 3101.

Table including address management information 3120 is configured with addrTable 3121, which is a definition for table 3120, addrentry 3122, which is an entry for table 3120, addrIndex node 3123, which is an index for table 3120, and addrData node 3124, which includes address management information.

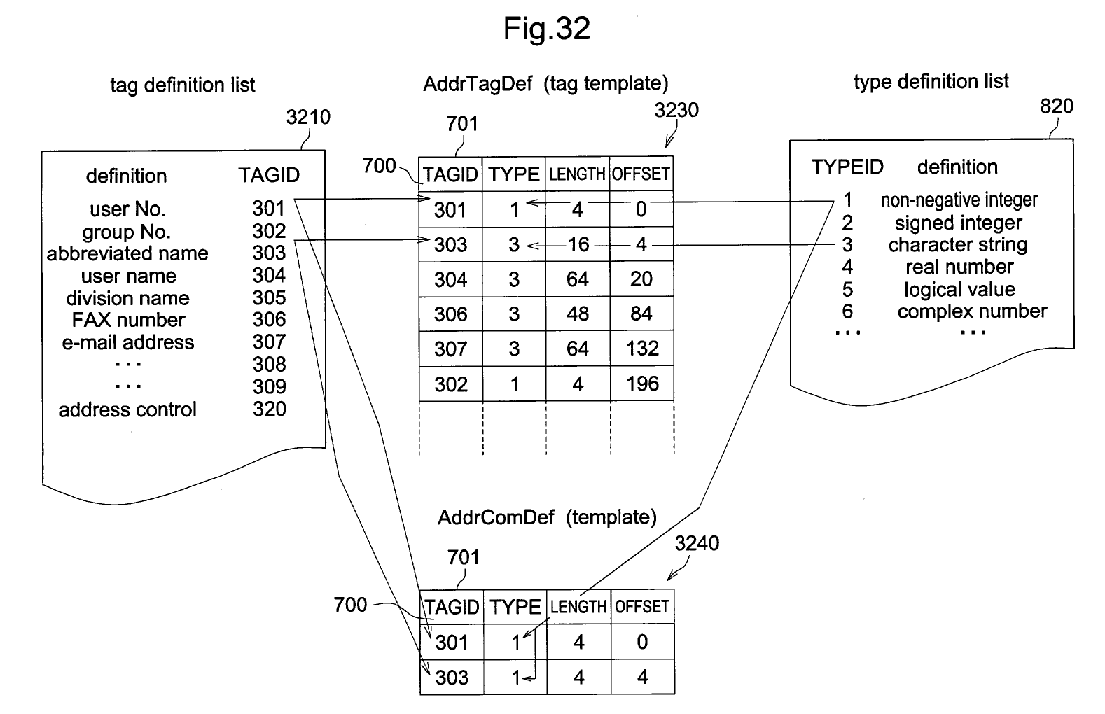

Next, FIG. 32 is used to illustrate the template for address management information description and template for address management information control command description. FIG. 32 illustrates the template for address management information description and template for address management information control command description according to the eighth embodiment.

Template for address management information description (addrTagDef) 3230 and template for address management information control command description (addrComDef) 3240 are defined as a set of data structure object 700, similar to JobTagDef 830 of the first embodiment.

Data tag number 701 has one value of the tag ID that is defined by tag definition list 3210.

Tag definition list 3210 is a table that associates TAGID with items relating to address management information. Tag definition list 3210 assigns TAGID 301 to user number, TAGID 302 to group number, TAGID 303 to abbreviated name, TAGID 304 to user name, TAGID 305 to user division name, TAGID 306 to user facsimile number, TAGID 307 to user e-mail address, and TAGID 320 to address control information that illustrates control contents of address management information stored in multifunctional printer 40.

Also, the address control information (TAGID 320) is used by addrComDef 3240.

“0” in address control information illustrates generating a new address management information, “1” illustrates deleting the address management information, and “2” illustrates changing the address management information.

In addition, tag template 3230 is provided as addrTagDef node 3110, and tag template is provided as addrComDef node 3130 for the MIB database of multifunctional printer 40. Accordingly, PC 10 can obtain tag template 3230 and tag template 3240 by making a request toward object ID 1.3.6.1.4.1.258.998.1 and object ID 1.3.6.1.4.1.258.998.3, respectively.

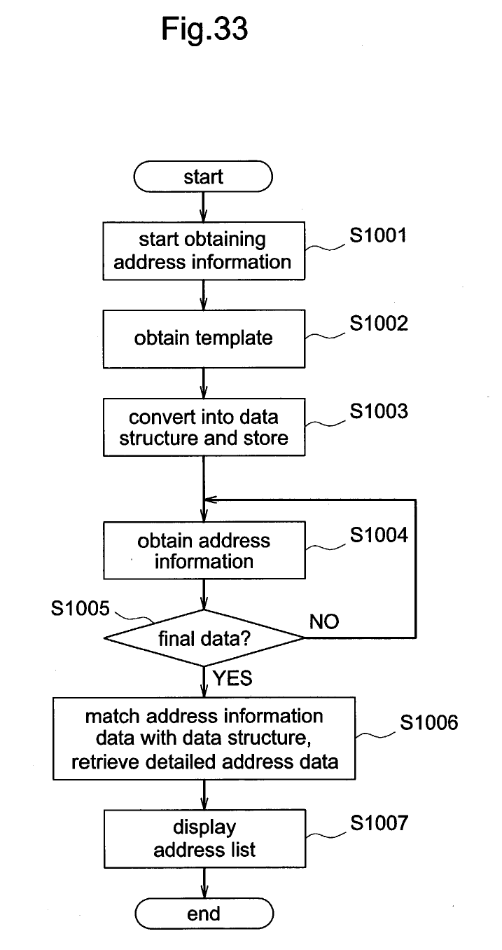

Next, FIG. 33 is used to illustrates an operation for obtaining the address management information in the apparatus management system according to the eighth embodiment. FIG. 33 is a flowchart illustrating the operation of a PC obtaining the address management information according to the eighth embodiment.

Control module 1005 of PC 10 starts obtaining the address management information, which is an MIB data structure transmitted form multifunctional printer 40, using SNMP communication module 1007 and MIB module 1006 (S1001).

First, control module 1005 obtains tag template 3230 by requesting to obtain addrTagDef 3110 from multifunctional printer 40 (S1002), converts the data into a data structure, and stores the same in RAM 201c (S1003).

Next, control module 1005 obtains individual address management information by transmitting a request to obtain addrData 3124 from multifunctional printer 40 (S1004). Upon obtaining all address management information (S1005), control module 1005 retrieves the data structure stored in RAM 201c at S1003, and matches the structure with the address management information, in order to decode the received address management information (S1006).

Upon completing decoding the address management information, control module 1005 transmits the decoded address management information to job display module 1008, so that job display module 1008 can display the list of address management information on a screen (S1007).

Accordingly, by separately storing tag template 3230, which is an item list and describes the encoding method, and address management information, which is actual structuralized data, so that they can be accessed with separate object IDs, it is possible to process the entire data in the table with one SNMP request. Therefore, it is possible to provide a more responsive management system.

In addition, according to the eighth embodiment, PC 10 can control the address management information stored in multifunctional printer 40. When the communication is conventionally performed simply using the SNMP, PC 10 is also required to transmit information multiple times, in case of having plurality of address management information units to be controlled. Therefore, in the eighth embodiment, encoded information regarding control method for address management information and its encoding method are communicated between PC 10 and multifunctional printer 40, so that information related to controlling a plurality of address management information units are transmitted in one communication cycle.

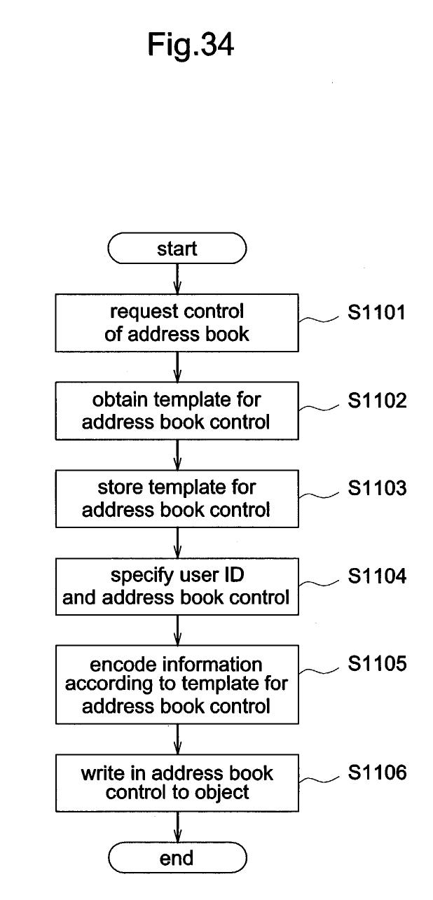

Hereafter, FIG. 34 is used to illustrate in detail, the address management information control of the apparatus management system according to the eighth embodiment. FIG. 34 is a flowchart illustrating the address management information control of a PC in the apparatus management system according to the eighth embodiment.

When PC 10 starts an address management information control (S1101), control module 1005 of PC 10 requests to obtain addrComDef 3130, which is actual data of template for address management information control 3240, from multifunctional printer 40, using SNMP communication module 1007 and MIB module 1006 (S1102). Then, control module 1005 of PC 10 obtains template for address management information control 3240, from multifunctional printer 40, via SNMP communication module 1007 and MIB module 1006 (S1103), and stores template 3240 in RAM 201c (S1104).

Next, control module 1005 specifies a user number to control the address management information and controlling content, and encodes the specified user number and address management information control in accordance with template 3240, which is obtained at S1103 (S1105).

Then, control module 1005 transmits the encoded information regarding the address management information control to multifunctional printer 40 by SET of the SNMP toward addrCommand 3140, so that address management information control is written in to address management information control object 3140 of multifunctional printer 40 (S1106).

As described above, according to the eighth embodiment, PC 10 transmits a user number and information regarding address management information control to multifunctional printer 40, so that a predetermined control can be performed for the address management information stored in the HDD.

Additionally, according to the eighth embodiment, PC 10 encodes the user number and information regarding the address management information control in accordance with the template, and transmits the same to multifunctional printer 40. Therefore, multifunctional printer 40 can analyze the encoded information based on the template. As a result, PC 10 can transmit the plurality of information items, such as a user number and information regarding the address management information control, to multifunctional printer 40, in one communication cycle. Accordingly, it is possible to lighten the communication load between PC 10 and multifunctional printer 40.

Ninth Embodiment

The ninth embodiment of the present invention is a extended variation of the second embodiment. In particular, a PC (manger) responds when tag definition list version and tag definition list version of a printer (agent) are different. Although originally, both sides need to synchronize for their tag definition list, this embodiment illustrates a situation where both sides cannot synchronize due to a tag addition from upgrading a version at one side.

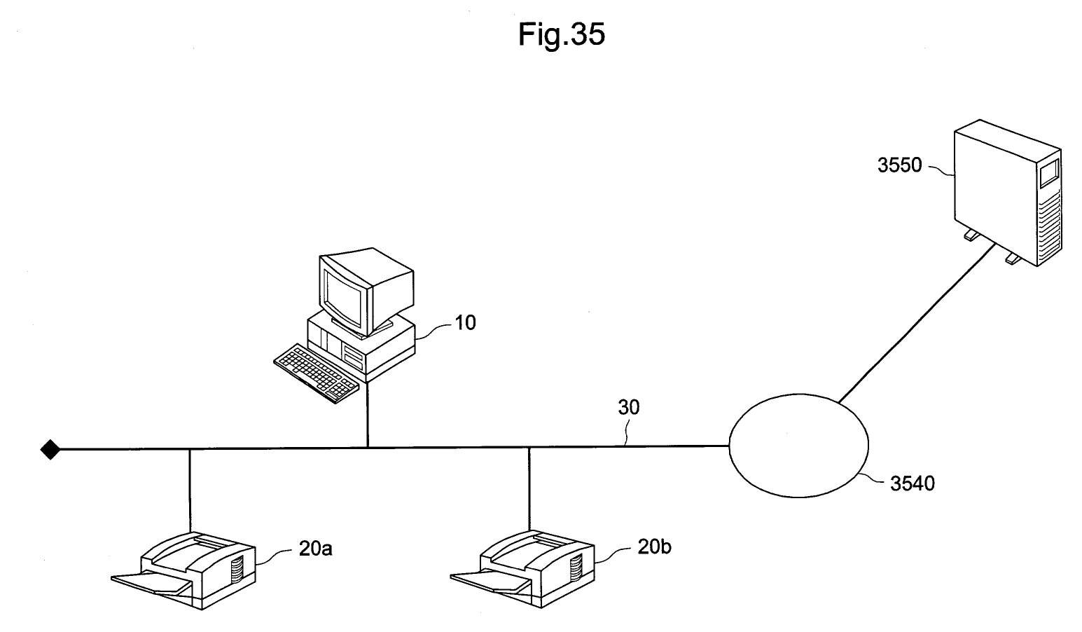

Hereafter, FIG. 35 is used to illustrate a apparatus management system according to the ninth embodiment. FIG. 35 illustrates a structure of the apparatus management system according to the ninth embodiment.

FIG. 35 includes Internet 3540, and tag definition list management server 3550 that stores a plurality of tag definition list versions. Additionally, PC 10 and printers 20a and 20b can access Internet 3540 via network 30. Since tag definition list management server 3550 is connected to Internet 3540, PC 10 and printers 20a and 20b can access tag definition list management server 3550 via Internet 3540.

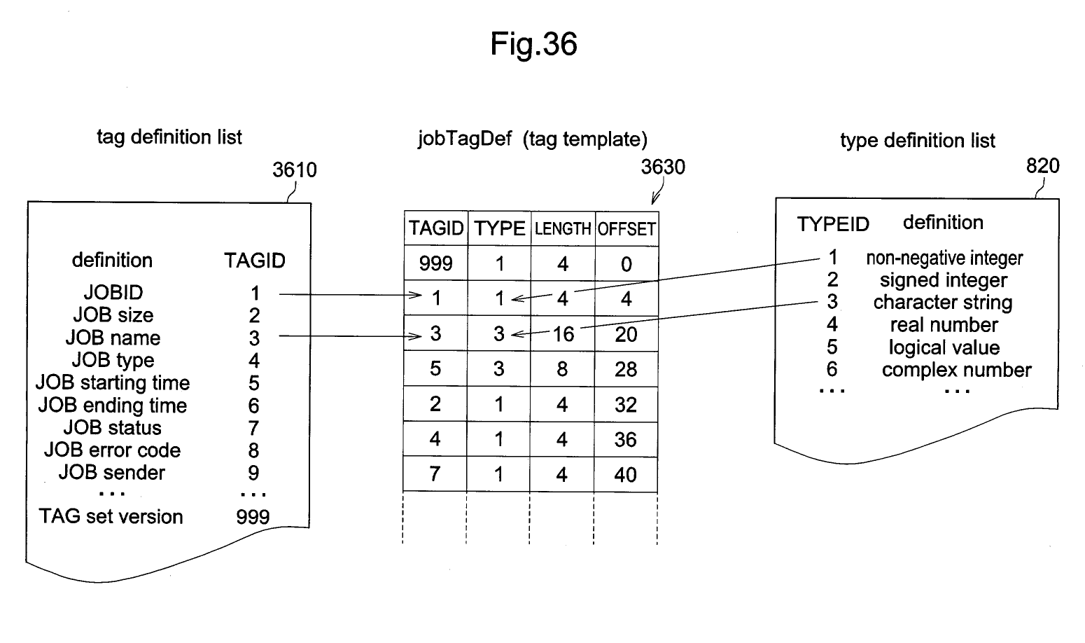

Next, FIG. 36 is used to illustrate a tag template that is used in the apparatus management system according to the ninth embodiment. FIG. 36 illustrates a method for defining the tag template according to the ninth embodiment.

Template for job control command description (jobTagDef) 3630 according to the ninth embodiment is defined as a set of data structure object 700, similar to JobTagDef 830 illustrated in the first embodiment.

Tag definition list 3610 is different from tag definition list 810 of the first embodiment in that TAGID 999 is assigned to a tag for job template version. Accordingly, by assigning a job control to TAGID 999, it is possible to request a tag definition list in template 3630.

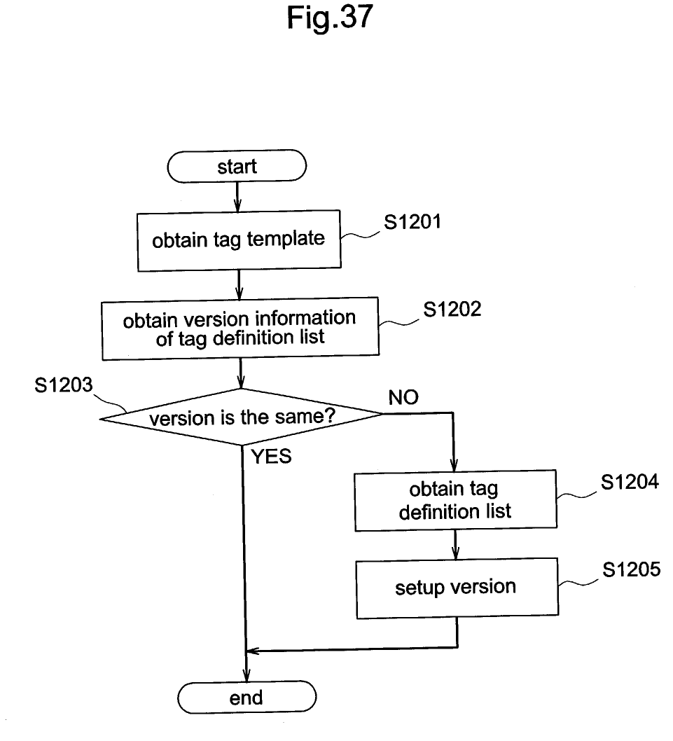

Next, FIG. 37 is used to illustrate an operation of updating the tag definition list in apparatus management system according to the ninth embodiment. FIG. 37 is a flowchart illustrating the operation of updating the tag definition list in apparatus management system according to the ninth embodiment. In this example, tag definition list version that can be analyzed by PC 10 (manager) is referred to as “A”, whereas tag definition list version that is used for encoding by printer 20 (agent) is referred to as “B”.

Prior to obtaining job status information, PC 10 obtains tag template 3630 from printer 20. Then, PC 10 obtains the version information of tag definition list 3610, which has been used to generate the obtained tag template (S1202).

Upon obtaining the version information of tag definition list 3610, PC 10 compares a version of tag definition list 3610 of tag template 3630, which is used for requesting job status information from printer 20, and a version of tag definition list 3610 for tag template 3630, which is just obtained from printer 20 (S1203).

Since these tag definition lists 3610 are different, in this example, PC 10 starts obtaining tag definition list 3610, which is used by printer 20.

By accessing tag definition list management server 3550 on Internet 3540, which is either pre-registered or specified by the user, and by accessing a Website for tag definition list management server 3550, PC 10 can obtain tag definition list 3610 with the version used by printer 20 (S1204). Also, PC 10 sets the version of tag definition list 3610, which is stored in PC 10, as “B” (S1205).

As described above, according to the ninth embodiment, even if tag definition lists used by PC 10 and printer 20 are different, PC 10 can obtain the tag definition list used by printer 20, from tag definition list management server 3550. Therefore, it is possible to enforce the tag definition list between PC 10 and printer 20, even if it increases the number of job information items when the function of printer 20 is updated. Therefore, it is possible for PC 10 to correctly decode the encoded information.

In the ninth embodiment, PC 10 (manager) accesses the website of Internet 3540 in order to automatically update the tag definition list. However, printer 20 may maintain the tag definition list, so that PC 10 can obtain the same. In addition, a configuration can be provided where a tag definition list, which is recorded in a medium such as a FD and CD-ROM, can be read when it is necessary.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

This application is based on the Japanese Patent Application No. 2001-344655 filed on Nov. 9, 2001, entire content of which is expressly incorporated by reference herein.

What is claimed is:

1. A communication apparatus connected to a computer terminal via a network, the communication apparatus including at least a printer function, the apparatus comprising:
a memory configured to store management information and encoding definition information, the management information including at least one of print job information, print job history log information, setup user information, and communicating destination address information, and the encoding definition information describing an encoding method of the management information;
an encoder that encodes the management information using the encoding definition information in said memory; and
a transmitter that transmits the encoded management information and encoding definition information using the SNMP protocol, based on a request from the computer terminal.

2. The communication apparatus according to claim 1, wherein the encoding definition information includes a type of the management information, a description method of the management information, a length of the management information, and a location information of the management information.

3. A computer terminal connected to a communication apparatus with at least a printer function, via a network, the computer terminal comprising:
a requester that makes a request toward the communication apparatus for management information including at least one of print job information, print job history log information, setup user information, and communicating destination address information;
a receiver that receives encoded management information and encoding definition information describing the encoding method, from the communication apparatus, using the SNMP protocol; and
a decoder that decodes the encoded management information based on the encoding definition information.

4. A computer terminal connected to a communication apparatus with at least a printer function, via a network, the computer terminal comprising:
a receiver that receives encoded management information and encoding definition information describing the encoding method, from the communication apparatus using the SNMP protocol, the management information includes at least one of print job information, print job history log information, setup user information, and communicating destination address information;
an encoder that encodes management information to be controlled and control contents, with the encoding method described in the encoding definition information; and
a transmitter that transmits the management information to be controlled and the control contents encoded by said encoder, to the communication apparatus using the SNMP protocol.

5. The computer terminal according to claim 4, wherein said transmitter transmits return address information for notifying whether a process of the control contents by the communication apparatus is normally performed, to the communication apparatus.

6. A management system comprising:
a plurality of communication apparatuses having a printer function; and
a computer terminal connected to said communication apparatuses via a network,
said computer terminal requesting from said communication apparatus for management information including at least one of print job information, print job history log information, setup user information, and communicating destination address information, using the SNMP protocol;
said communication apparatus transmitting encoded management information and encoding definition information describing the encoding method to said computer using the SNMP protocol, upon receiving the request; and
said computer terminal decoding the encoded management information based on the encoding definition information upon receiving the encoded management information and encoding definition information.

7. The management system according to claim 6, said computer terminal further comprising:
a memory configured to store the received encoding definition information;
an obtainer that obtain version information of the encoding definition information from said communication apparatus, upon receiving the encoded management information from said communication apparatus;
a comparator that compares the version information with version information of the pre-stored encoding definition information;
a decoder that decodes the encoded management information using the pre-stored encoding definition information, when the version information of the received encoding definition information is the same as the version information of the pre-stored encoding definition information; and
a requester that requests the encoding definition information of the new version from said communication apparatus, when the version information of the received encoding definition information is different from the version information of the pre-stored encoding definition information;
wherein said decoder decodes the encoded management information using the encoding definition information with the new version;
wherein said memory stores the encoding definition information with the new version.

8. A management system comprising:
a plurality of communication apparatuses having a printer function; and
a computer terminal connected to said communication apparatuses via a network,
said computer terminal obtaining encoding definition information that describes an encoding method from said communication apparatus using the SNMP protocol, encoding management information to be controlled and control contents within management information including at least one of print job information, print job history log information, setup user information, and communicating destination address information, all of which being stored by said communication apparatus, in the encoding method described in the encoding definition information; and transmitting the encoded management information to be controlled and control contents to said communication apparatus using the SNMP protocol;
said communication apparatus decoding the encoded management information to be controlled and control contents using the encoding definition information, upon receiving the encoded management information to be controlled and control contents; and performing a process illustrated by the control contents on the decoded management information to be controlled.

9. The management system according to claim 8, wherein the management information to be controlled is described using an identifier assigned for each type, the correspondence between the type and the identifier is pre-arranged between said communication apparatus and said computer terminal.

10. The management system according to claim 9, wherein a definition table, having the corresponding information between the management information to be controlled and the identifier assigned for each type, includes a version number, and wherein when a version number of the definition table stored by said communication apparatus is different from a version number of the definition table stored by said computer terminal, said computer terminal accesses a management apparatus managing definition tables of a plurality of versions, setup on the network, and obtains a definition table with the same version as of said communication apparatus.

11. A method for transmitting management information, utilizing a communication apparatus connected to a computer terminal via a network, the communication apparatus having at least a printer function, the method comprising:
storing management information and encoding definition information, the management information including at least one of print job information, print job history log information, setup user information, and communicating destination address information, and the encoding definition information describing an encoding method of the management information;
encoding the management information using the encoding definition information; and
transmitting the encoded management information and encoding definition information based on a request from the computer terminal, using the SNMP protocol.

12. A method for obtaining management information, utilizing a computer terminal connected to a communication apparatus having at least a printer function, via a network, the method comprising:
requesting management information including at least one of print job information, print job history log information, setup user information, and communicating destination address information, from the communication apparatus;
receiving encoded management information and encoding definition information describing the encoding method from the communication apparatus, using the SNMP protocol; and
decoding the encoded management information based on the encoding definition information.

13. A method for managing a communication apparatus, utilizing a computer terminal connected to the communication apparatus having at least a printer function, via a network, the method comprising:
receiving management information and encoding definition information from the communication apparatus using the SNMP protocol, the management information including at least one of print job information, print job history log information, setup user information, and communicating destination address information, and the encoding definition information describing the encoding method;
encoding the management information to be controlled and control contents using the encoding method described in the encoding definition information; and
transmitting the encoded management information to be controlled and control contents to the communication apparatus using the SNMP protocol.
